(19) United States
(12) Patent Application Publication
(10) Pub. No.: US 2025/0184077 A1
(43) Pub. Date: Jun. 5, 2025

(54) TD-OCC OVER NONCONSECUTIVE DM-RS SYMBOLS

(71) Applicant: Telefonaktiebolaget LM Ericsson (publ), Stockholm (SE)

(72) Inventors: Sven Jacobsson, Västra Frölunda (SE); Andreas Nilsson, Göteborg (SE); Mattias Frenne, Uppsala (SE); Per Ernström, Stockholm (SE); Jianwei Zhang, Solna (SE)

(21) Appl. No.: 18/845,023

(22) PCT Filed: Mar. 10, 2023
(86) PCT No.: PCT/IB2023/052333

§ 371 Date: Sep. 9, 2024

Related U.S. Application Data
(60) Provisional application No. 63/319,186, filed on Mar. 11, 2022.

(51) Int. Cl. H04L 5/00

(52) U.S. Cl. CPC H04L 5/0051; H04L 5/0016

(57) ABSTRACT

Systems and methods are disclosed that provide Time Domain Orthogonal Cover Codes (TD-OCC) over nonconsecutive Demodulation Reference Signal (DMRS) symbols. In one embodiment, a method performed by a radio node comprises estimating channel characteristics or receiving channel characteristics through signaling and, depending on the channel characteristics, performing DMRS Orthogonal Cover Code (OCC) decoding based on either: (a) sub-length orthogonal Frequency Domain OCC (FD-OCC) combined with sub-length orthogonal TD-OCC over one or more additional DMRS symbols or (b) FD-OCC. In this manner, more orthogonal DMRS ports can be supported.

### RELATED APPLICATIONS

This application claims the benefit of provisional patent application Ser. No. 63/319,186, filed Mar. 11, 2022, the disclosure of which is hereby incorporated herein by reference in its entirety.

### TECHNICAL FIELD

The present disclosure relates to a cellular communications system and, more specifically, to transmission of Demodulation Reference Signals (DMRS).

### BACKGROUND

### DM-RS for PUSCH

Demodulation Reference Signal (DM-RS) for Physical Uplink Shared Channel (PUSCH) is an uplink (UL) reference signal that consists of a pseudo-random Quadrature Phase-Shift Keying (QPSK) sequence for Cyclic Prefix Orthogonal Frequency Division Multiplexing (CP-OFDM) or low Peak-to-Average Power Ratio (PAPR) sequences for Discrete Fourier Transform (DFT) Spread Orthogonal Frequency Division Multiplexing (DFT-S-OFDM). The DM-RS for PUSCH is used for demodulating of PUSCH such that the receiver (i.e., the New Radio (NR) base station (gNB)) can handle time-varying and frequency-selective channels. DM-RS is confined to the scheduled PUSCH bandwidth and duration.

The mapping of DM-RS to REs is configurable in both frequency and time domain. In the frequency domain, there are two mapping types: type 1 (comb based) or type 2 (non-comb based). In the time-domain, DM-RS can be either single symbol or double symbol, where the latter means that DM-RS is mapped in pairs of two adjacent symbols. Furthermore, a User Equipment (UE) can be configured with one, two, three, or four single-symbol DM-RS and one or two double-symbol DM-RS. In low-Doppler scenarios, one DM-RS symbol may be sufficient, whereas in high-Doppler scenarios, additional DM-RS symbols are required.

The frequency-domain starting position of DM-RS is the same as the frequency-domain starting position of PUSCH. The time-domain starting position of DM-RS depends on the PUSCH mapping type:
For PUSCH mapping type A (slot-based scheduling), the first DM-RS symbol is in the third or fourth symbol (i.e., symbol 2 or 3) of a slot, configured by higher-layer parameter dmrs-TypeA-Position in the Master Information Block (MIB).
For PUSCH mapping type B (non-slot-based scheduling), the first DM-RS symbol of a slot is the same as the first PUSCH symbol of a slot.

DM-RS for PUSCH is Radio Resource Control (RRC) configured through the DMRS-UplinkConfig Information Element (IE), for PUSCH scheduled by Downlink Control Information (DCI) format 0_1 or DCI format 0_2.

DM-RS for PUSCH is configurable with respect to, e.g.,
The DM-RS frequency-domain mapping type (type 1 or type 2), configured by the RRC parameter dmrs-Type. Type 1 is comb based with 2 Code Division Multiplexing (CDM) groups whereas type 2 is not comb based with 3 CDM groups. For DFT-S-OFDM, only type 1 is supported. In FIGS. 1A and 1B, an illustration of the two DM-RS types is provided. Note that there are multiple DM-RS ports per CDM group, which are separated using frequency-domain (and time-domain, for double-symbol DM-RS) Orthogonal Cover Code(s) (OCC(s)):
   For single-symbol DM-RS, there exist 4 and 6 orthogonal DM-RS ports (2 DM-RS ports per CDM group, separated using a length-2 Frequency Domain OCC (FD-OCC)) for type 1 and type 2, respectively.
   For double-symbol DM-RS, there exist 8 and 12 orthogonal DM-RS ports (4 DM-RS ports per CDM group, separated using a length-2 FD-OCC combined with a length-2 Time Domain OCC (TD-OCC)) for type 1 and type 2, respectively.
Any additional DM-RS symbols (0, 1, 2 or 3 for single-symbol DM-RS and 0 or 1 for double-symbol DM-RS), configured by the RRC parameter dmrs-AdditionalPosition. The position of additional DM-RS symbols depends on the PUSCH mapping type and PUSCH duration according to a predefined table. In FIG. 2, an example of single-symbol (left part of the figure) and double-symbol (right part of the figure) DM-RS with 2 and 1 additional DM-RS symbol(s), respectively, is shown. FIG. 2 illustrates an example of single-symbol DM-RS with two additional single-symbol DM-RS (left part of the figure) and double-symbol DM-RS with one additional double-symbol DM-RS (right part of the figure). The figure is valid for DM-RS type 1 and front-loaded PUSCH (i.e., PUSCH mapping type A) of duration 14 symbols. Here, dmrs-TypeA-Position is set to 2.
The associated Phase Tracking Reference Signal (PT-RS) (if any), configured by the RRC parameter phaseTrackingRS.
The maximum number of adjacent DM-RS symbols (1 or 2), configured by the RRC parameter maxLength.

If transform precoding is disabled (i.e., if the waveform is CP-OFDM), DM-RS for PUSCH can be additionally and optionally configured with respect to scrambling ID 0 and 1, configured by RRC parameters scramblingID0 and scramblingID1, respectively, which are used for generating the pseudo-random DM-RS sequence.

DM-RS ports are mapped to resource elements within one CDM group. DM-RS ports that belong to the same CDM group are separated by a length-2 FD-OCC (and a length-2 TD-OCC, for double-symbol DM-RS). In NR Rel-16, the DM-RS sequence is mapped to the following subcarriers (for DFT-S-OFDM, only DM-RS type 1 is supported):

$$k = \{ \begin{matrix}4 n + 2 {k}^{′} + Δ , & for type 1 , \\ 6 n + {k}^{′} + Δ , & for type 2.\end{matrix}$$

Here, k is the subcarrier index (which starts/ends at the first/last subcarrier within the scheduled PUSCH bandwidth), n∈{0,1,2, . . . }, k′∈{0,1}, and Δ is an offset that depends on the CDM group.

In Table 1 and Table 2, port-specific parameters for DM-RS type 1 and type 2 are shown. Here, w_{f}(k′), where k′∈{0,1}, is the FD-OCC and wₜ(l′), where l′=0 for single-symbol DM-RS and l′∈{0,1} for double-symbol DM-RS, is the TD-OCC. Note that DM-RS ports in different CDM groups are separated by different offsets and that DM-RS ports within the same CDM group are separated through coding.

TABLE 1
Parameters for PUSCH DM-RS configuration type 1
(reproduced from Table 6.4.1.1.3−1 of 3GPP TS
38.211). Here, \tilde{p} denotes the DM-RS port.

| | | |
|---|---|---|
| CDM | | |
| group | w_{f} (k′) | wₜ (l′) |

| ^{\tilde{p}} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 2
Parameters for PUSCH DM-RS configuration type 2
(reproduced from Table 6.4.1.1.3-2 of 3GPP TS 38.211).
Here, \tilde{p} denotes the DM-RS port.

| | | |
|---|---|---|
| CDM | | |
| group | w_{f} (k′) | wₜ (l′) |

| ^{\tilde{p}} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

From the transmitter's perspective, the number of DM-RS ports used for PUSCH transmission coincides with the transmission rank, i.e., one DM-RS port per transmitted layer. The DM-RS port mapping is signaled to the UE from the gNB via DCI. Table 3 and Table 4 show how such indication looks for DCI 0_1, CP-OFDM, single-symbol DM-RS type 1, and for transmission rank 1 and 2, respectively. Similar tables can be found in 3GPP 38.212 for rank 3 and 4, double-symbol DM-RS, and for DM-RS type 2. Subcarriers, which are associated with a CDM group, that are not used for DM-RS can be used for PUSCH. After layer mapping, the DM-RS and the associated PUSCH are mapped to physical antennas through precoding. Table 3: Antenna ports for single-symbol DM-RS type 1, transform precoding is disabled, rank-1 transmission (reproduced from Table 7.3.1.1.2-8 of 3GPP 38.212).

TABLE 3
Antenna ports for single-symbol DM-RS type 1, transform
precoding is disabled, rank-1 transmission (reproduced
from Table 7.3.1.1.2-8 of 3GPP 38.212).

| Value | Number of DMRS CDM group(s) without data | DMRS port(s) |
|---|---|---|
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 4
Antenna ports for single-symbol DM-RS type 1, transform
precoding is disabled, rank-2 transmission (reproduced
from Table 7.3.1.1.2-9 of 3GPP 38.212).

| Value | Number of DMRS CDM group(s) without data | DMRS port(s) |
|---|---|---|
| 0 | 1 | 0, 1 |
| 1 | 2 | 0, 1 |
| 2 | 2 | 2, 3 |
| 3 | 2 | 0, 2 |
| 4-7 | Reserved | Reserved |

### DM-RS for PDSCH

DM-RS for Physical Downlink Shared Channel (PDSCH) is a downlink (DL) reference signal used for demodulating PDSCH. It is the DL counterpart to DM-RS for PUSCH and is similar, e.g., in terms of RRC configuration, time-and-frequency resource allocation, and port mapping to DM-RS for PUSCH except it is supported for CP-OFDM only (since DFT-S-OFDM is not supported in the DL of NR).

As mentioned above, time-and-frequency allocation and port mapping for DM-RS for PDSCH is similar (identical in many aspects) to DM-RS for PUSCH.

### SUMMARY

Systems and methods are disclosed that provide Time Domain Orthogonal Cover Codes (TD-OCC) over nonconsecutive Demodulation Reference Signal (DMRS) symbols. In one embodiment, a method performed by a radio node comprises estimating channel characteristics or receiving channel characteristics through signaling and, depending on the channel characteristics, performing DMRS Orthogonal Cover Code (OCC) decoding based on either: (a) sub-length orthogonal Frequency Domain OCC (FD-OCC) combined with sub-length orthogonal TD-OCC over one or more additional DMRS symbols or (b) FD-OCC. In this manner, more orthogonal DMRS ports can be supported without increasing DMRS overhead.

Corresponding embodiments of a radio node are also disclosed. In one embodiment, a radio node comprises a communication interface comprising a receiver and processing circuitry associated with the communication interface. The processing circuitry is configured to cause the radio node to estimate channel characteristics or receiving channel characteristics through signaling and, depending on the channel characteristics, perform DMRS OCC decoding based on either: (a) sub-length orthogonal FD-OCC combined with sub-length orthogonal TD-OCC over one or more additional DMRS symbols or (b) FD-OCC.

In another embodiment, a method performed by a radio node comprises transmitting Physical Downlink Shared Channel (PDSCH) or Physical Uplink Shared Channel (PUSCH) DMRS using TD-OCC over additional DMRS symbols and FD-OCC, such that the DMRS ports are separable based on FD-OCC and such that the DMRS ports are separable based on TD-OCC over additional DMRS symbols. In one embodiment, a separate FD-OCC is applied for each of the DMRS ports and a separate TD-OCC is applied for each of the DMRS ports.

Corresponding embodiments of a radio node are also disclosed. In one embodiment, a radio node comprises a communication interface comprising a transmitter and processing circuitry associated with the communication interface. The processing circuitry is configured to cause the radio node to transmit PDSCH or PUSCH DMRS using TD-OCC over additional DMRS symbols and FD-OCC, such that the DMRS ports are separable based on FD-OCC and such that the DMRS ports are separable based on TD-OCC over additional DMRS symbols. In one embodiment, a separate FD-OCC is applied for each of the DMRS ports and a separate TD-OCC is applied for each of the DMRS ports.

In another embodiment, a method performed by a radio node comprises transmitting PDSCH or PUSCH DMRS using TD-OCC over additional DMRS symbols and FD-OCC, such that the DMRS ports are separable based on full length FD-OCC and such that the DMRS ports are separable based on sublength FD-OCC combined with TD-OCC over additional DMRS symbol. In one embodiment, a separate FD-OCC is applied for each of the DMRS ports and a separate TD-OCC is applied for DMRS ports for which the applied FD-OCC are not sublength orthogonal.

Corresponding embodiments of a radio node are also disclosed. In one embodiment, a radio node comprises a communication interface comprising a transmitter and processing circuitry associated with the communication interface. The processing circuitry is configured to cause the radio node to transmit PDSCH or PUSCH DMRS using TD-OCC over additional DMRS symbols and FD-OCC, such that the DMRS ports are separable based on full length FD-OCC and such that the DMRS ports are separable based on sublength FD-OCC combined with TD-OCC over additional DMRS symbol. In one embodiment, a separate FD-OCC is applied for each of the DMRS ports and a separate TD-OCC is applied for DMRS ports for which the applied FD-OCC are not sublength orthogonal.

In another embodiment, a method performed by a User Equipment (UE) comprises receiving, from a network node, information that configures the UE to assume length X Time TD-OCC weights across X non-adjacent Orthogonal Frequency Division Multiplexing (OFDM) symbols associated with a scheduled PDSCH or PUSCH DMRS.

In one embodiment, X is one of a defined set of values. In one embodiment, the defined set of values is {2, 3, 4}.

In one embodiment, a value of X is explicitly configured. In another embodiment, a value of X is implicitly configured. In one embodiment, X is implicitly configured to Nadd+1 for single-symbol DMRS, where Nadd is a number of additional DMRS symbols. In another embodiment, X is implicitly configured to 2Nadd+2 for double-symbol DMRS, where Nadd is a number of additional DMRS symbols.

In one embodiment, the method further comprises receiving information from the network node that schedules a PDSCH or PUSH for the UE. In one embodiment, a duration of the scheduled PDSCH or PUSCH does not encompass X DMRS symbols, and the UE: assumes that TD-OCC is not used for the scheduled PDSCH or PUSCH DMRS, or assumes that TD-OCC is used over PDSCH or PUSCH DMRS symbols that are within the duration of the scheduled PDSCH or PUSCH. In another embodiment, a duration of the scheduled PDSCH or PUSCH does not encompass X DMRS symbols, and the UE assumes TD-OCC is used for the scheduled PDSCH or PUSCH DMRS if indicated in Downlink Control Information (DCI).

In one embodiment, the method further comprises receiving the scheduled PDSCH DMRS or transmitting the scheduled PUSCH DMRS, in accordance with the assumption.

Corresponding embodiments of a UE are also disclosed. In one embodiment, a UE comprises a communication interface comprising a receiver, and processing circuitry associated with the communication interface. The processing circuitry is configured to cause the UE to receive, from a network node, information that configures the UE to assume length X TD-OCC weights across X non-adjacent OFDM symbols associated with a scheduled PDSCH or PUSCH DMRS.

In another embodiment, a method performed by a UE comprises receiving, from a network node, information that indicates presence or absence of TD-OCC weights across non-adjacent Demodulation Reference Signal, DMRS, symbols.

In one embodiment, receiving the information comprises receiving the information via Radio Resource Control (RRC) signaling or DCI.

In one embodiment, the method further comprises performing PDSCH DMRS reception or PUSCH DMRS transmission, in accordance with the received information that indicates presence or absence of TD-OCC weights across non-adjacent DMRS symbols.

Corresponding embodiments of a UE are also disclosed. In one embodiment, a UE comprises a communication interface comprising a receiver, and processing circuitry associated with the communication interface. The processing circuitry is configured to cause the UE to receive, from a network node, information that indicates presence or absence of TD-OCC weights across non-adjacent DMRS symbols.

In another embodiment, a method performed by a radio node comprises transmitting PDSCH or PUSCH DMRS, using sub-length orthogonal TD-OCC over additional DMRS symbols.

In one embodiment, transmitting the PDSCH or PUSCH DMRS using sub-length orthogonal TD-OCC over additional DMRS symbols comprises, for single-symbol DMRS and two additional DMRS, transmitting the PDSCH or PUSCH DMRS using OCC weights applied over all DMRS OFDM symbols in a slot such that: length two vectors with elements equal to the weights applied to a first and second DMRS OFDM symbols in the slot constitute OCC codes and length two vectors with elements equal to the weights applied to the second and third DMRS OFDM symbols in the slot constitute OCC codes.

In one embodiment, transmitting the PDSCH or PUSCH DMRS using sub-length orthogonal TD-OCC over additional DMRS symbols comprises, for single-symbol DMRS and three additional DMRS, transmitting the PDSCH or PUSCH DMRS using TD-OCC weights applied over all DMRS OFDM symbols in a slot such that: length two vectors with elements equal to the weights applied to a first and second DMRS OFDM symbols in the slot constitute OCC codes, length two vectors with elements equal to the weights applied to the second and third DMRS OFDM symbols in the slot constitute OCC codes, and length two vectors with elements equal to the weights applied to the third and fourth DMRS OFDM symbols in the slot constitute OCC codes.

Corresponding embodiments of a radio node are also disclosed. In one embodiment, a radio node comprises a communication interface comprising a transmitter and processing circuitry associated with the communication interface. The processing circuitry is configured to cause the radio node to transmit PDSCH or PUSCH DMRS using sub-length orthogonal TD-OCC over additional DMRS symbols.

In another embodiment, a method performed by a radio node comprises performing TD-OCC decoding of sub-length orthogonal TD-OCC over additional DMRS symbols.

In one embodiment, performing the TD-OCC decoding of sub-length orthogonal TD-OCC over additional DMRS symbols comprises, for single-symbol DMRS and two additional DMRS, performing TD-OCC based separation of DMRS ports separately for a first and second DMRS OFDM symbols in a slot and the second and third DMRS OFDM symbols in the slot.

In one embodiment, performing the TD-OCC decoding of sub-length orthogonal TD-OCC over additional DMRS symbols comprises, for single-symbol DMRS and two additional DMRS, performing TD-OCC based separation of DMRS ports separately for a first and second DMRS OFDM symbols in a slot, the second and third DMRS OFDM symbols in the slot, and the third and fourth DMRS OFDM symbols in the slot.

Corresponding embodiments of a radio node are also disclosed. In one embodiment, a radio node comprises a communication interface comprising a receiver, and processing circuitry associated with the communication interface. The processing circuitry is configured to cause the radio node to perform TD-OCC decoding of sub-length orthogonal TD-OCC over additional DMRS symbols.

In another embodiment, a method performed by a radio node comprises estimating channel characteristics or receiving channel characteristics through signaling and, depending on the channel characteristics, performing DMRS OCC decoding based on either: (a) TD-OCC, over one or more additional DMRS symbols or (b) FD-OCC.

Corresponding embodiments of a radio node are also disclosed. In one embodiment, a radio node comprises a communication interface comprising a receiver, and processing circuitry associated with the communication interface. The processing circuitry is configured to cause the radio node to estimate channel characteristics or receiving channel characteristics through signaling and, depending on the channel characteristics, perform DMRS OCC decoding based on either: (a) TD-OCC over one or more additional DMRS symbols or (b) FD-OCC.

In another embodiment, a method performed by a network node comprises transmitting, to a UE, information that configures the UE to assume length X TD-OCC weights across X non-adjacent OFDM symbols associated with a scheduled PDSCH or PUSCH DMRS.

In another embodiment, a method performed by a network node comprises transmitting, to a UE, information that indicates presence or absence of TD-OCC weights across non-adjacent DMRS symbols.

In another embodiment, a method performed by network node comprises transmitting PDSCH DMRS using sub-length orthogonal TD-OCC over additional DMRS symbols.

In another embodiment, a method performed by a network node comprises performing TD-OCC decoding of sub-length orthogonal TD-OCC over additional DMRS symbols.

In another embodiment, a method performed by a radio node comprises estimating channel characteristics or receiving channel characteristics through signaling and, depending on the channel characteristics, performing DMRS OCC decoding based on either: (a) orthogonal TD-OCC over one or more additional DMRS symbols or (b) FD-OCC.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1A and 1B illustrate two Demodulation Reference Signal (DM-RS) types;

FIG. 2 illustrates an example of single-symbol DM-RS with two additional single-symbol DM-RS (left part of the figure) and double-symbol DM-RS with one additional double-symbol DM-RS (right part of the figure);

FIG. 3 illustrates a procedure in accordance with one embodiment;

FIG. 4 illustrates one example embodiment in which a network node (e.g., New Radio (NR) base station (gNB) or gNB-Central Unit (CU) or gNB-Distributed Unit (DU)) signals, to a User Equipment (UE), presence or absence of Time Domain Orthogonal Cover Code (TD-OCC) weights across non-adjacent DMRS symbols;

FIG. 5 is a flow chart that illustrates the operation of a radio node (e.g., a network node such as a base station (e.g., gNB or gNB-DU) or a UE) in accordance with one embodiment of the present disclosure in which sub-length orthogonal TD-OCC over additional DMRS symbols is used;

FIG. 6 is a flow chart that illustrates the operation of a radio node (e.g., a network node such as a base station (e.g., gNB or gNB-DU) or a UE) in accordance with one embodiment of the present disclosure in which TD-OCC decoding of sub-length orthogonal TD-OCC over additional DMRS symbols is provided;

FIG. 7 illustrates the operation of radio node to perform OCC decoding based on sub-length orthogonal Frequency Domain Orthogonal Cover Code (FD-OCC) coupled to sub-length orthogonal TD-OCC over additional DMRS symbols in accordance with an embodiment of the present disclosure;

FIG. 8 illustrates the operation of radio node to perform OCC decoding based on sub-length orthogonal FD-OCC coupled to sub-length orthogonal TD-OCC over additional DMRS symbols in accordance with another embodiment of the present disclosure;

FIG. 9 illustrates indexing of DMRS symbols (shaded) for double symbol, one additional DMRS configuration for a 14-symbol slot;

FIG. 10 illustrates indexing of DMRS symbols (shaded) for a single symbol, two additional DMRS configuration for a 14-symbol slot;

FIG. 11 is an illustration of how parameters for PDSCH DM-RS configuration type 1 as currently defined in Table 7.4.1.1.2-2 in 3GPP Technical Specification (TS) 38.211 can be updated to support TD-OCC over up to four (consecutive and/or non-consecutive) OFDM symbols for the same Code Division Multiplexing (CDM) group, in accordance with an embodiment of the present disclosure;

FIG. 12 illustrates one example of a RRC configuration for DL DMRS, in accordance with an embodiment of the present disclosure;

FIG. 13 illustrates another embodiment where a new RRC parameter indicates that TD-OCC over non-consecutive OFDM symbols are supported (if configured), and it indicates over how many total OFDM symbols the TD-OCC could span at maximum (2 or 4 in this example);

FIG. 14 shows an example of a communication system in accordance with some embodiments;

FIG. 15 shows a UE in accordance with some embodiments;

FIG. 16 shows a network node in accordance with some embodiments;

FIG. 17 is a block diagram of a host, which may be an embodiment of the host of FIG. 14, in accordance with various aspects described herein;

FIG. 18 is a block diagram illustrating a virtualization environment in which functions implemented by some embodiments may be virtualized; and

FIG. 19 shows a communication diagram of a host communicating via a network node with a UE over a partially wireless connection in accordance with some embodiments.

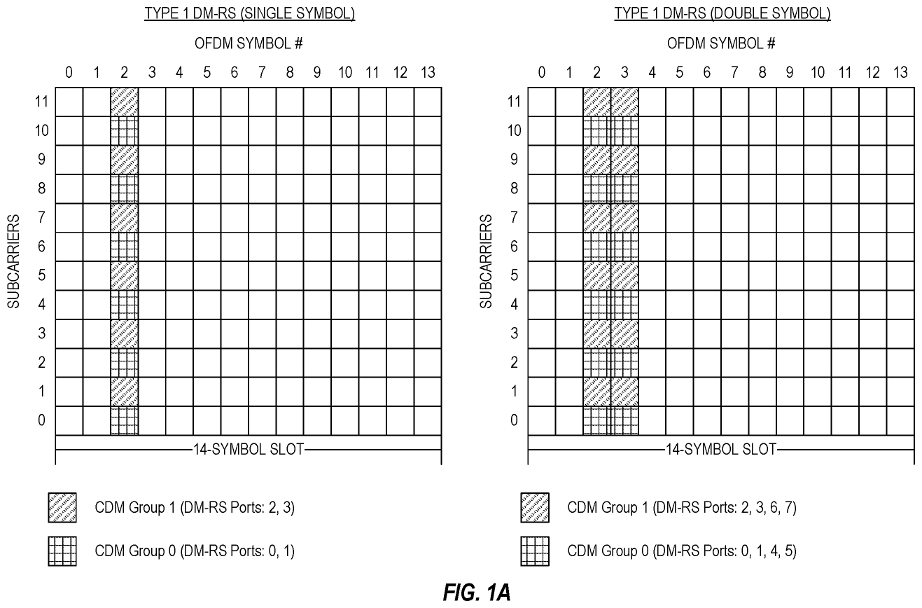

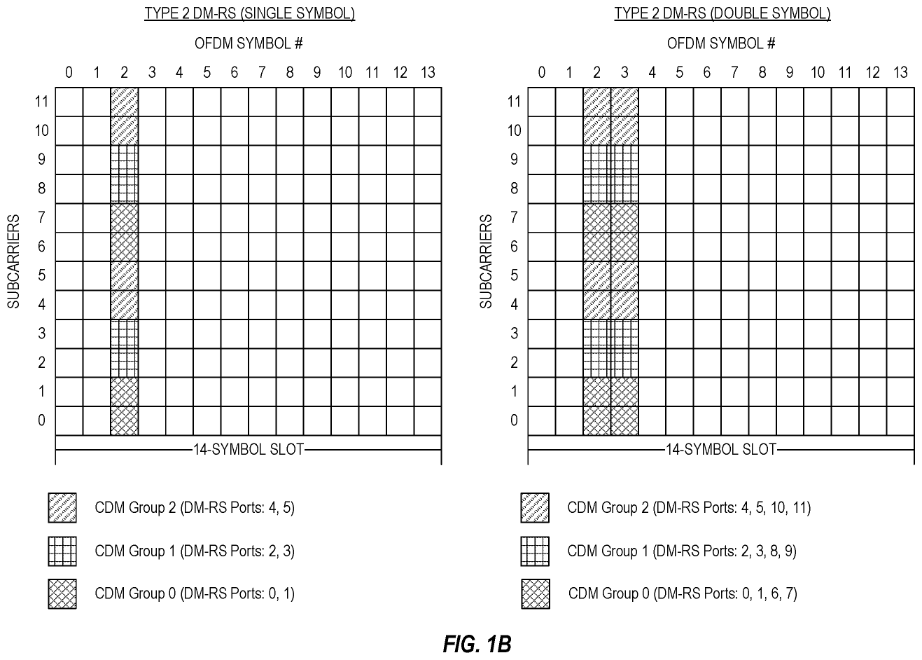

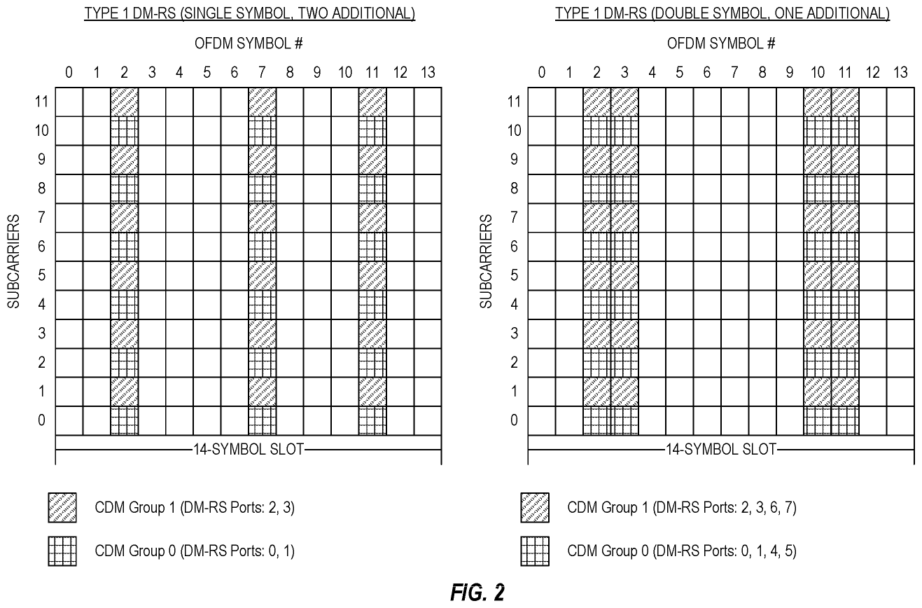

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In the current 3GPP NR specification, a maximum of 8 orthogonal DMRS ports for “DMRS Type 1” and a maximum of 12 orthogonal DMRS ports for “DMRS Type 2” are supported. However, for Multi-User Multiple-Input Multiple-Output (MU-MIMO) where several UEs are scheduled simultaneously, the maximum number of orthogonal DMRS might become a limiting factor. In addition, to support 8 orthogonal DMRS ports for DMRS Type 1, and 12 orthogonal DMRS ports for DMRS Type 2, “Double symbol” DMRS must be used, which increases the DMRS overhead. Hence, there is a need to increase the number of orthogonal DMRS ports without increasing the DMRS overhead. How to do this is still an open issue.

Certain aspects of the disclosure and their embodiments may provide solutions to these or other challenges. Systems and methods are disclosed herein that provide a framework for increasing the maximum number of orthogonal DMRS ports by introducing higher Time Division Orthogonal Cover Code (TD-OCC) over non-consecutive DMRS ports.

Embodiments are disclosed herein that provide TD-OCC weights over the additional DMRS symbols in a slot, such that TD-OCC based port separation can be done based on subsets of the DMRS symbols (e.g., sub-length orthogonal TD-OCC over additional DMRS symbols).

Embodiments are also disclosed for signaling to control the use of TD-OCC over additional DMRS symbols (e.g., for sub-length orthogonal TD-OCC over additional DMRS symbols, as well as for other variants of TD-OCC over additional DMRS symbols).

Some more details are given below.

### Signaling for Length X TD-OCC Limitation:

In one embodiment, the presence/absence of TD-OCC weights across non-adjacent DMRS symbols depends on higher layer configuration and dynamic (per scheduled Physical Downlink Shared Channel (PDSCH)/Physical Uplink Shared Channel (PUSCH)) indication. In particular, in one embodiment, it is dependent on at least the duration of the scheduled PDSCH/PUSCH which impacts the number of DMRS symbols.

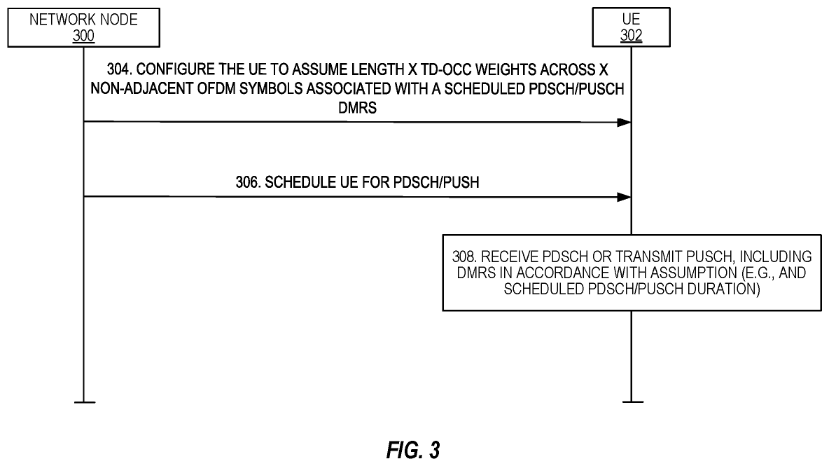

FIG. 3 illustrates a procedure in accordance with one embodiment. This procedure involves a network node 300 (e.g., a gNB or gNB-DU) and a UE 302. The steps of the procedure are as follows:
Step 304: The network node 300 configures the UE 302 to assume length X TD-OCC weights across X non-adjacent OFDM symbols associated with a scheduled PDSCH or PUSCH (denoted herein as “PDSCH/PUSCH”) DMRS.
   The UE 302 can be configured with one or multiple X values, e.g., from the set X=2,3,4
      The value(s) of X are explicitly configured, or
      The value X is implicitly set to N_{add}+1 for single-symbol DMRS, where N_{add} is the number of additional DMRS symbols (see Background section above for further details), or
      The value X is implicitly set to 2N_{add}+2 for double-symbol DMRS.
   In one embodiment, if a certain value X is not configured, then the UE 302 assumes legacy (up to Rel.17) behavior for the DMRS when X non-adjacent symbols is used for the scheduled PDSCH/PUSCH.
   In one embodiment, the above application of TD-OCC only applies when the UE 302 is scheduled from Physical Downlink Control Channel (PDCCH) using Cell Radio Network Temporary Identifier (C-RNTI) and/or scheduled from a UE specific search space.
Step 306: The network node 300 schedules the UE 302 for a PDSCH reception or PUSCH transmission. In other words, the network 300 sends, to the UE 302, a DCI including information that schedules the UE 302 for a PDSCH reception or PUSCH transmission.
   If scheduled PDSCH/PUSCH duration l_{d} does not provide a duration that encompasses X DMRS symbols, then:
      The UE 302 assumes that TD-OCC is not used for the scheduled PDSCH/PUSCH DMRS and/or the UE 302 assumes that TD-OCC are used over the Y<X PDSCH/PUSCH DMRS symbols that are within the scheduled PDSCH/PUSCH duration.
      The UE 302 may not expect to be scheduled with ports that is associated with an TD-OCC configured or TD-OCC other than “all ones” (which is equivalent functionality wise).
      The UE 302 may assume that TD-OCC across DMRS is not used for another co-scheduled UE either.
   If scheduled PDSCH/PUSCH duration l_{d} provides a duration that encompasses X DMRS symbols, and TD-OCC is configured for this value of X, then:
      The UE 302 assumes that TD-OCC is used for the scheduled PDSCH/PUSCH DMRS or
      The UE assumes that TD-OCC is used for the scheduled PDSCH/PUSCH DMRS if indicated in DCI, e.g. in the case the antenna port indication table (3GPP TS 38.212) contains some entries (Value), which has TD-OCC enabled and some entries does not have such TD-OCC enabled.
Step 308: The UE 302 performs PDSCH reception (including PDSCH DMRS reception) or PUSCH transmission (including PUSCH DMRS transmission) in accordance with the assumption(s) made above.

### Signaling to Enable Extended TD-OCC:

In one embodiment, the presence/absence of TD-OCC weights across non-adjacent DMRS symbols is signaled, e.g., over RRC, (e.g., per scheduled PDSCH/PUSCH). When presence is signaled, the UE assumes that TD-OCC weights are applied to all DMRS symbols in the slot.

In one embodiment, the presence/absence of TD-OCC weights across non-adjacent DMRS symbols is indicated by DCI. When presence is indicated, the UE assumes that TD-OCC weights are applied to all DMRS symbols in the slot.

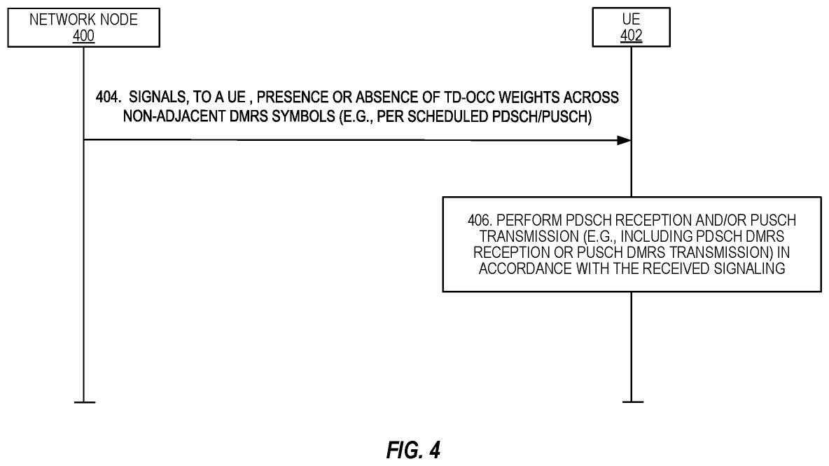

FIG. 4 illustrates one example embodiment in which a network node 400 (e.g., gNB or gNB-Central Unit (CU) or gNB-Distributed Unit (DU)) signals, to a UE 402, presence or absence of TD-OCC weights across non-adjacent DMRS symbols. As illustrated, the network node 400 signals, to the UE 402, presence or absence of TD-OCC weights across non-adjacent DMRS symbols (e.g., per scheduled PDSCH/PUSCH) (step 404). This signaling may be via RRC or DCI. The UE 402 then performs PDSCH reception and/or PUSCH transmission (e.g., including PDSCH DMRS reception or PUSCH DMRS transmission) in accordance with the received signaling (step 406).

### Sub-Length Orthogonal TD-OCC Over Additional DMRS Symbols:

In one embodiment, for single symbol DMRS with three or four additional symbols, port and symbol dependent weights are applied across all PDSCH/PUSCH DMRS OFDM symbols in a slot, such that the weights over any two consecutive DMRS OFDM symbols in the slot form OCC vectors.

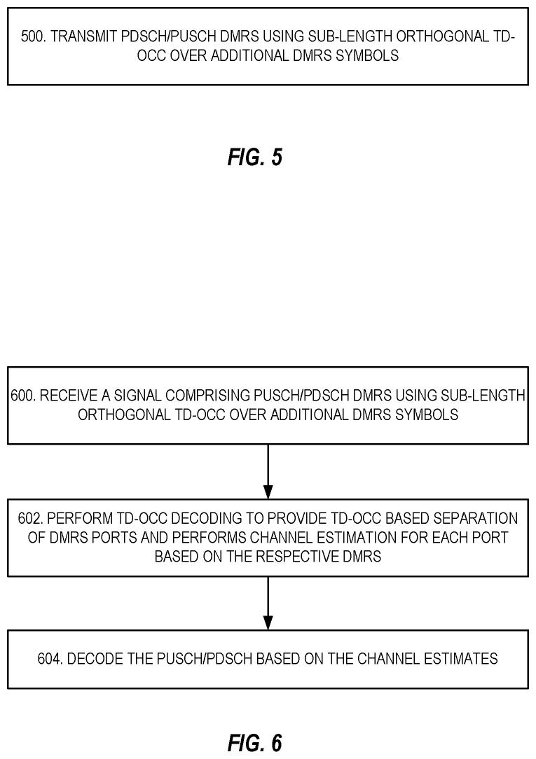

FIG. 5 is a flow chart that illustrates the operation of a radio node (e.g., a network node such as a base station (e.g., gNB or gNB-DU) or a UE) in accordance with one embodiment of the present disclosure in which sub-length orthogonal TD-OCC over additional DMRS symbols is used. As illustrated, the radio node transmits PDSCH/PUSCH DMRS using sub-length orthogonal TD-OCC over additional DMRS symbols (step 500).
For the case of single symbol DMRS and two additional DMRS, TD-OCC weights are applied by the transmitter over all DMRS OFDM symbols in the slot such that:
   The length two vectors with elements equal to the weights applied to the first and the second DMRS OFDM symbol in the slot, constitute OCC codes (i.e., if two such vectors corresponding to different ports are not identical, they are orthogonal)
   The length two vectors with elements equal to the weights applied to the second and the third DMRS OFDM symbol in the slot, constitute OCC codes (i.e., if two such vectors corresponding to different ports are not identical, they are orthogonal)
For the case of single symbol DMRS and three additional DMRS, TD-OCC weights are applied by the transmitter over all DMRS OFDM symbols in the slot such that:
   The length two vectors with elements equal to the weights applied to the first and the second DMRS OFDM symbol in the slot, constitute OCC codes (i.e., if two such vectors corresponding to different ports are not identical, they are orthogonal)
   The length two vectors with elements equal to the weights applied to the second and the third DMRS OFDM symbol in the slot, constitute OCC codes (i.e., if two such vectors corresponding to different ports are not identical, they are orthogonal)
   The length two vectors with elements equal to the weights applied to the third and the fourth DMRS OFDM symbol in the slot, constitute OCC codes (i.e., if two such vectors corresponding to different ports are not identical, they are orthogonal)

### TD-OCC Decoding of Sub-Length Orthogonal TD-OCC Over Additional DMRS Symbols:

In one embodiment, for single symbol DMRS with three or four additional symbols, the receiver performs TD-OCC based separation of ports for each pair of two consecutive DMRS OFDM symbols in the slot.

FIG. 6 is a flow chart that illustrates the operation of a radio node (e.g., a network node such as a base station (e.g., gNB or gNB-DU) or a UE) in accordance with one embodiment of the present disclosure in which TD-OCC decoding of sub-length orthogonal TD-OCC over additional DMRS symbols is provided. As illustrated, the radio node receives a signal comprising PUSCH/PDSCH DMRS using sub-length orthogonal TD-OCC over additional DMRS symbols (step 600). The radio node performs TD-OCC decoding to provide TD-OCC based separation of DMRS ports and performs channel estimation for each port based on the respective DMRS (step 602). The radio node then decodes the PUSCH/PDSCH based on the channel estimates (step 604). In regard to TD-OCC decoding:
For the case of single symbol DMRS and two additional DMRS, the receiver performs TD-OCC based separation of ports separately for:
   The first and the second DMRS OFDM symbol in the slot
   The second and the third DMRS OFDM symbol in the slot
For the case of single symbol DMRS and three additional DMRS, the receiver performs TD-OCC based separation of ports separately for:
   The first and the second DMRS OFDM symbol in the slot
   The second and the third DMRS OFDM symbol in the slot
   The third and the fourth DMRS OFDM symbol in the slot

### OCC Decoding Based on Sub-Length Orthogonal FD-OCC Coupled to Sub-Length Orthogonal TD-OCC Over Additional DMRS Symbols

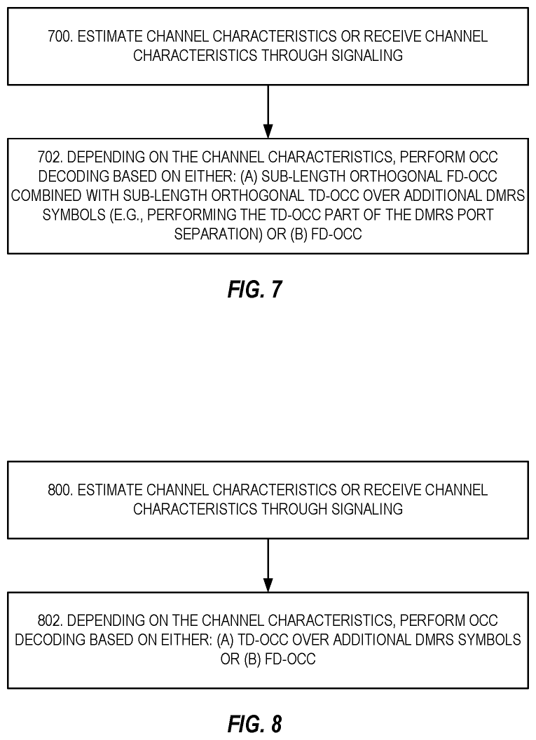

As illustrated in FIG. 7, in one embodiment:
Step 700: The receiver of the radio node (e.g., UE in the case of PDSCH or network node such as, e.g., gNB or gNB-DU in the case of PUSCH) estimates channel characteristics or receives channel characteristics through signaling.
Step 702: Depending on channel characteristics, the receiver of the radio node performs OCC decoding based on either
   Sub-length orthogonal FD-OCC combined with sub-length orthogonal TD-OCC over additional DMRS symbols (performing the TD-OCC part of the port separation, e.g. as described herein), or
   FD-OCC.

As illustrated in FIG. 8, in another embodiment:
Step 800: The receiver of the radio node (e.g., UE in the case of PDSCH or network node such as, e.g., gNB or gNB-DU in the case of PUSCH) estimates channel characteristics or receives channel characteristics through signaling.
Step 802: Depending on channel characteristics, the receiver of the radio node performs OCC decoding based on either:
   TD-OCC over additional DMRS symbols (e.g., as described above in the text describing “TD-OCC decoding of sub-length orthogonal TD-OCC over additional DMRS symbols”), or
   FD-OCC.

In one embodiment the channel characteristics referred to in the description of “OCC decoding based on sub-length orthogonal FD-OCC coupled to sub-length orthogonal TD-OCC over additional DMRS symbols” include Doppler spread and Delay spread.

Certain embodiments may provide one or more of the following technical advantage(s). Embodiments of the present disclosure support more orthogonal DMRS ports in NR in such a way that robustness towards both delay spread and doppler spread can be achieved. Embodiments of the present disclosure achieve improved robustness against delay spread for the number of ports supported in earlier NR releases (Rel 17 and earlier) while limiting the susceptibility to doppler spread. Embodiments of the present disclosure support more orthogonal DMRS ports in NR without increasing DMRS overhead which can increase the capacity for DL and/or UL MU-MIMO since more UEs can be served simultaneously.

Now, further description of some embodiments of the present disclosure is provided.

### 1 TD-OCC Embodiments

### 1.1 TD-OCC Nomenclature

Let N_{add}∈{0,1, 2, 3} be the number of additional DMRS symbols. Let n_{c}∈{1, 2}, be the number of contiguous DMRS symbols, i.e., n_{c}=1 for single symbol DMRS and n_{c}=2 for double symbol DMRS.

Let l_{td}∈{0,1, . . . ,n_{c}·(N_{add}+1)−1} index all the DMRS symbols in a slot in order of time independently of whether they are contiguous or additional DMRS symbols.

Define an additional DMRS symbol index as

$${l}_{a} = ⌊ \frac{{l}_{td}}{{n}_{c}} ⌋$$

Note that this index is the same for two contiguous DMRS symbols but varies between additional symbols (single symbol DMRS case) or pairs of additional symbols (double symbol DMRS case).

Define a contiguous symbol index as

$${l}^{′} = {l}_{td} mod {n}_{c}$$

Note that this index is equal to 0 for the first symbol of two contiguous DMRS symbols and equal to 1 for the second symbol of two contiguous DMRS symbols, independently of additional symbol positions.

Note also that the l_{td} can be deduced from lₐ and l′, and vice versa:

$${l}_{td} = {l}_{a} \cdot {n}_{c} + {l}^{′} ⇔ \{ \begin{matrix}{l}_{a} = ⌊ \frac{{l}_{td}}{{n}_{c}} ⌋ \\ {l}^{′} = {l}_{td} mod {n}_{c}\end{matrix}$$

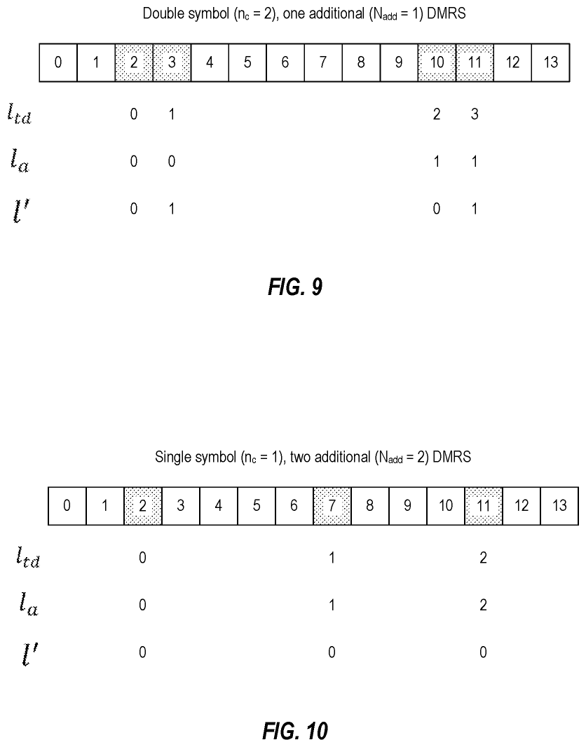

In FIG. 9 and FIG. 10, this indexing is illustrated for two DMRS configurations. FIG. 9 illustrates indexing of DMRS symbols (shaded) for double symbol, one additional DMRS configuration for a 14-symbol slot. FIG. 10 illustrates indexing of DMRS symbols (shaded) for a single symbol, two additional DMRS configuration for a 14-symbol slot.

In NR release 17, FD-OCC codes and TD-OCC codes for single/double symbol DMRS are applied through the use of port-dependent weight factor w_{f} (k′) and wₜ(l′) in the mapping of the Quadrature Phase Shift Keying (QPSK) sequence r to resource elements (k, l)_{p,μ}, as follows for Type-1 PDSCH DMRS (similar equations for Type-2 PDSCH DMRS (and for Type-1 and Type-2 PUSCH DMRS) can be found in 3GPP TS 38.211):

$$\begin{matrix}{a}_{k , l}^{( p , μ )} = {β}_{P DSCH}^{D M R S} {w}_{f} ( {k}^{′} ) {w}_{t} ( {l}^{′} ) r ( 2 n + {k}^{′} ) \\ k = 12 n + 2 {k}^{′} + Δ \\ {k}^{′} = 0 , 1 , … , 5 \\ l = \overline{l} + {l}^{′} \\ n = 0 , 1 , …\end{matrix}$$

In one embodiment, this is extended to TD-OCC codes over both double symbol DMRS and additional DMRS symbols using a weight function w_{td}(l_{td}) in the mapping of the QPSK sequence r to resource elements (k, l)_{p,μ}, as

$${a}_{k , l}^{( p , μ )} = {β}_{PDSCH}^{DMRS} {w}_{f} ( {k}^{′} ) {w}_{td} ( {l}_{td} ) r ( 2 n + {k}^{′} )$$

$$k = 12 n + 2 {k}^{′} + Δ$$

$${k}^{′} = 0 , 1 , ... , 5$$

$$l = \overline{l} + {l}^{′}$$

$${l}^{′} = {l}_{td} mod {n}_{c}$$

$$n = 0 , 1 , ...$$

In an alternative embodiment, separate A-TD-OCC (Additional DMRS TD-OCC) factors wₜₐ(lₐ) are applied over the additional DMRS symbols, independently of the TD-OCC factors wₜ(l′) used to apply OCC codes over double symbol DMRS. This A-TD-OCC factor is then applied as an additional multiplicative factor when mapping the QPSK sequence r to resource elements (k, l)_{p,μ}, i.e.

$${a}_{k , l}^{( p , μ )} = {β}_{PDSCH}^{DMRS} {w}_{f} ( {k}^{′} ) {w}_{t} ( {l}^{′} ) {w}_{ta} ( {l}_{a} ) r ( 2 n + {k}^{′} )$$

$$k = 12 n + 2 {k}^{′} + Δ$$

$${k}^{′} = 0 , 1 , ... , 5$$

$$l = \overline{l} + {l}^{′}$$

$$n = 0 , 1 , ...$$

Note that the formulation above based on separate A-TD-OCC and TD-OCC weight factors can always be reformulated in terms of combined TD-OCC weight factors by defining

$${w}_{td} ( {l}_{td} ) = {w}_{t} ( {l}_{t} mod {n}_{c} ) \cdot {w}_{ta} ( ⌊ \frac{{l}_{td}}{{n}_{c}} ⌋ ) = {w}_{t} ( {l}^{′} ) \cdot {w}_{ta} ( {l}_{a} ) .$$

One may also note that for the case of single symbol DMRS (n_{c}=1), we have l′=0 which means that wₜ(l′) just gives a common factor which we can equally well set to 1. Since we also have l_{td}=lₐ, the two formulations become identical for single symbol DMRS with wₜ(l′)=1 and wₜₐ(lₐ)=w_{td}(l_{td}). The A-TD-OCC factors wₜₐ(lₐ) constitute the elements of A-TD-OCC vectors (or equivalently A-TD-OCC codes) w̅ₜₐ. A number N_{vec} of different A-TD-OCC vectors, w̅_{ta,m} mϵ{0,1, . . . , N_{A}-TD-OCC}, are used for different ports. The mapping of a port to a A-TD-OCC vector may be described by a mapping function gₜₐ(p), i.e., w̅_{ta,g}_{ₜₐ}(p) is the A-TD-OCC vector used for port p.

The analogous terminology can be used for the FD-OCC, TD-OCC for consecutive DMRS, and for TD-OCC for consecutive and additional DMRS, i.e. w̅_{f,g}_{_{f}}₍ₚ₎ is the FD-OCC vector used for port p, and w̅_{t,g}_{ₜ}₍ₚ₎ is the TD-OCC vector for double symbol DMRS used for port p and w̅_{td,g}_{_{td}}₍ₚ₎ is the TD-OCC vector for double symbol and additional DMRS used for port p.

In the NR specification, the OCC vectors and the mapping functions are typically not directly defined. Instead, the mapping from ports directly to OCC factors (or equivalently OCC vector elements) w_{f}(k′), wₜ(l′) and potentially also wₜₐ(lₐ) and w_{td}(l_{td}) is given. Based on the mapping of ports to OCC vector elements, the OCC vectors and port mapping functions to OCC vectors can easily be constructed by the following simple steps (example for w̅ₜₐ case):
1. For each port, construct the corresponding OCC vector w̅ₜₐ with elements lₐ equal to the weight wₜₐ(lₐ) to which the port is mapped (e.g., as given by tabulated wₜₐ(lₐ) per port).
2. Among the vectors for all ports identify all unique vectors. This is the set of OCC vectors.
3. Number the OCC vectors.
4. For each port find the number m of the unique vector ta for which vector element lₐ is equal to the weight wₜₐ(lₐ) to which the port is mapped for all lₐ and set gₜₐ(p)=m.

### 1.2 Sub-Length Orthogonal TD-OCC Over Additional DMRS Symbols

In a first embodiment, we use separate A-TD-OCC factors wₜₐ(lₐ) to apply OCC codes over the additional DMRS symbols, independently of the TD-OCC factors wₜ(l′) used to apply OCC codes over the consecutive DMRS symbols. A number of A-TD-OCC vectors w̅_{ta,n} with elements w_{ta,n}(lₐ) are used such that the vectors are orthogonal over any two consecutive vector elements, i.e.

$${\sum }_{{l}_{a} = b}^{b + 1} {w}_{ta , m} ( {l}_{a} ) \cdot \overline{{w}_{ta , n} ( {l}_{a} )} = 0 ∀ m \neq n , b ∈ \{ 0 , 1 , ... , {N}_{add} - 1 \}$$

An example of such A-TD-OCC vectors for three additional DMRS are

$${\overline{w}}_{ta , 0} = {[ + 1 , + 1 , + 1 , + 1 ]}^{T}$$

$${\overline{w}}_{ta , 1} = {[ + 1 , - 1 , + 1 , - 1 ]}^{T}$$

An example of such A-TD-OCC vectors for two additional DMRS are

$${\overline{w}}_{ta , 0} = {[ + 1 , + 1 , + 1 ]}^{T}$$

$${\overline{w}}_{ta , 1} = {[ + 1 , - 1 , + 1 ]}^{T}$$

Note that these A-TD-OCC vectors are used in several of the more detailed embodiments described in later subsections such as in 1.3.2 and 1.4.1.

The receiver uses the orthogonality property described above to separate ports using subsets of the DMRS OFDM symbols.

In the case of two additional DMRS symbols, the receiver utilizes two subsets:
DMRS symbols for which lₐ∈{0, 1}
DMRS symbols for which lₐ∈{1, 2}

In the case of three additional DMRS symbols, the receiver utilizes three subsets:
DMRS symbols for which lₐ∈{0, 1}
DMRS symbols for which lₐ∈{1, 2}
DMRS symbols for which lₐ∈{2, 3}

For each port and subset of DMRS symbols, the receiver makes a raw channel estimate which is an estimate of the channel at the average time of the DMRS symbols in the subset used. The receiver interpolates, extrapolates, and filters the raw channel estimates to the symbol times for which PUSCH transmissions, i.e., to the symbol times for which channel estimates are needed.

In a second alternative embodiment, we use joint TD-OCC factors w_{td}(l_{td}). In the case of single symbol DMRS, we use joint TD-OCC factors w_{td}(l_{td}) such that

$${\sum }_{{l}_{td} = b}^{b + 1} {w}_{td , m} ( {l}_{td} ) \cdot \overline{{w}_{td , n} ( {l}_{td} )} = 0 ∀ m \neq n , b ∈ \{ 0 , 1 , ... , {N}_{add} - 1 \}$$

while in the case of double symbol DMRS we use joint TD-OCC factors w_{td}(l_{td}) such that

$${\sum }_{{l}_{td} = 2 b}^{2 b + 3} {w}_{td , m} ( {l}_{td} ) \cdot \overline{{w}_{ta , n} ( {l}_{td} )} = 0 ∀ m \neq n , b ∈ \{ 0 , 1 , ... , {N}_{add} - 1 \}$$

The receiver uses these orthogonality properties to separate ports and perform channel estimation, using subsets of the DMRS symbols as described above.

In the case single symbol DMRS and two additional DMRS symbols the receiver utilize two subsets
DMRS symbols for which l_{td}∈{0, 1}
DMRS symbols for which l_{td}∈{1, 2}

In the case of single symbol DMRS and three additional DMRS symbols the receiver utilize three subsets
DMRS symbols for which l_{td}∈{0, 1}
DMRS symbols for which l_{td}∈{1, 2}
DMRS symbols for which l_{td}∈{2, 3}

The benefit of the embodiments in this subsection (and the more detailed embodiment in 1.3.2 and 1.4.1) is that despite using TD-OCC codes over additional symbols, channel variations in time due to, e.g., frequency offsets, Doppler shifts and Doppler spread can still be taken into account in channel estimation. This results in robustness against frequency offsets, Doppler shifts and Doppler spread as compared to using OCC-codes over all DMRS symbols within a slot to separate ports.

### 1.3 TD-OCC Over Additional DMRS Symbols to Increase the Number of Ports

Note that the explicitly described embodiments are for “DMRS Type 1”, however, they can easily be extended to “DMRS Type 2” in a similar way.

### 1.3.1 TD-OCC Over Additional DMRS Symbols for Single Symbol DMRS Configurations

In this embodiment, we use a weight function w_{td}(l_{td}), l_{td}∈{0,1, . . . , n_{c}, (N_{add}+1)−1}, to apply a TD-OCC code over all DMRS symbols, contiguous as well as additional.

Table 5 illustrates one schematic example of this for single symbol DMRS. One benefit with this solution, compared to current standard specification of NR, is that if one wants to have four orthogonal DMRS ports within one CDM group, and one wants to have one DMRS transmission close to the beginning of the slot and one DMRS transmission close to the end of the slot, only two OFDM symbols have to be occupied by the DMRS transmission, compared to 4 OFDM symbols which had to be occupied with current NR specification to attain the four orthogonal DMRS ports (which will save DMRS overhead).

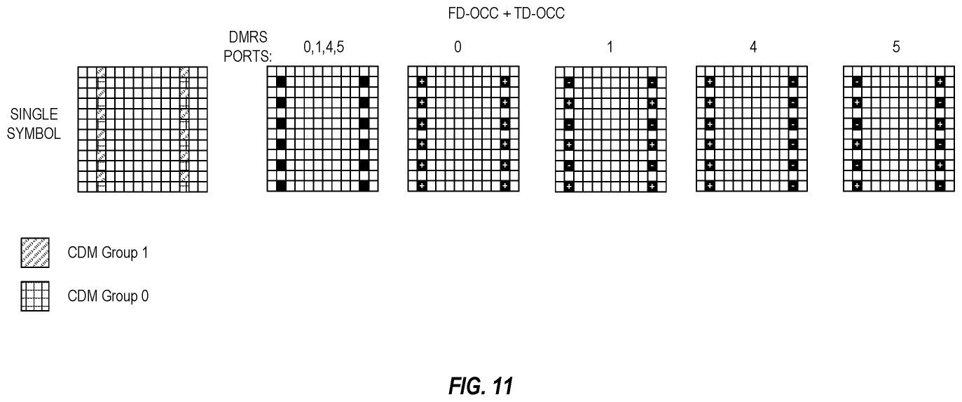

In Table 5, the rows for port numbers 1008 to 1015 correspond to new DMRS port numbers, where up to 16 orthogonal DMRS ports now can be supported instead of only 8 orthogonal DMRS ports as in current NR specification. The extended TD-OCC coding is introduced by two new columns (columns for l_{d}=2 and l_{d}=3), which gives the TD-OCC coding for the 3^{rd} and 4^{th} OFDM symbol. Note that these two columns are only needed in case the total number of OFDM symbols in the slot is equal to 4. In case only two OFDM symbols is used for DMRS (as in the example seen in FIG. 11), then only a subset of the Table 5 is needed (marked with bold lines, i.e., section defined by rows for ports 1000 to 1007 and columns from left to right ending at and including the column for l_{d}=1). These two OFDM symbols can be either consecutive or non-consecutive.

Note that this is just one example of what the new table might look like, and the exact DMRS port mapping to TD-OCC parameter setting might look differently.

Note that in this example, the number of OFDM symbols covered by TD-OCC per CDM group is extended to four; however, the number of OFDM symbols covered by TD-OCC per CDM group can easily be extended to for example 8, in case even more orthogonal DMRS ports are desired.

Note that this embodiment is illustrated for “DMRS Type 1”, however, it can easily be extended to “DMRS Type 2” in a similar way.

TABLE 5
Parameters for PDSCH configuration type with TD-OCC over non-consecutive DMRS

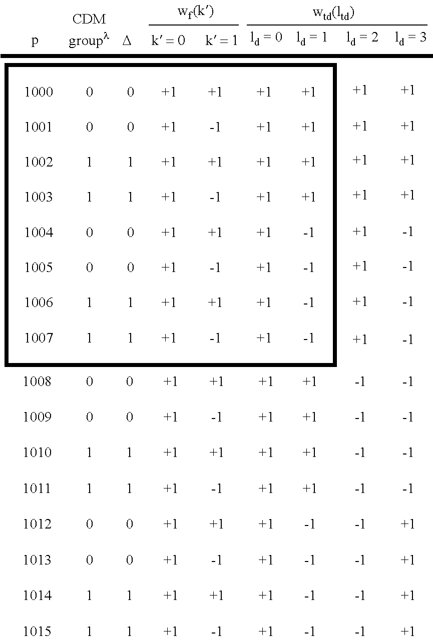

| | DM-RS positions l̅ | | | | | | | |
|---|---|---|---|---|---|---|---|---|
| | PDSCH mapping type A | | | | PDSCH mapping type B | | | |
| | dmrs-AdditionalPosition | | | | dmrs-AdditionalPosition | | | |
| l_{d} in symbols | pos0 | pos1 | pos2 | pos3 | pos0 | pos1 | pos2 | pos3 |
| 2 | — | — | — | — | l₀ | l₀ | l₀ | l₀ |
| 3 | l₀ | l₀ | l₀ | l₀ | l₀- | l₀- | l₀ | l₀- |
| 4 | l₀ | l₀ | l₀ | l₀ | l₀ | l₀ | l₀ | l₀ |
| 5 | l₀ | l₀ | l₀ | l₀ | l₀- | l₀, 4- | l₀, 4 | l₀, 4 |
| 6 | l₀ | l₀ | l₀ | l₀ | l₀ | l₀, 4 | l₀, 4 | l₀, 4 |
| 7 | l₀ | l₀ | l₀ | l₀ | l₀ | l₀, 4 | l₀, 4 | l₀, 4 |
| 8 | l₀ | l₀, 7 | l₀, 7 | l₀, 7 | l₀- | l₀, 6- | l₀, 3, 6 | l₀, 3, 6 |
| 9 | l₀ | l₀, 7 | l₀, 7 | l₀, 7 | l₀- | l₀, 7- | l₀, 4, 7 | l₀, 4, 7 |
| 10 | l₀ | l₀, 9 | l₀, 6, 9 | l₀, 6, 9 | l₀- | l₀, 7- | l₀, 4, 7 | l₀, 4, 7 |
| 11 | l₀ | l₀, 9 | l₀, 6, 9 | l₀, 6, 9 | l₀- | l₀, 8- | l₀, 4, 8 | l₀, 3, 6, 9 |
| 12 | l₀ | l₀, 7 | l₀, 6, 9 | l₀, 5, 8, 11 | l₀- | l₀, 9- | l₀, 5, 9 | l₀, 3, 6, 9 |
| 13 | l₀ | l₀, ζ | l₀, 7, 11 | l₀, 5, 8, 11 | l₀- | l₀, 9- | l₀, 5, 9 | l₀, 3, 6, 9 |
| 14 | l₀ | l₀, ζ | l₀, 7, 11 | l₀, 5, 8, 11 | — | — | — | — |

| | DM-RS positions l̅ | | | | | |
|---|---|---|---|---|---|---|
| | PDSCH mapping type A | | | PDSCH mapping type B | | |
| | dmrs-AdditionalPosition | | | dmrs-AdditionalPosition | | |
| l_{d} in symbols | pos0 | pos1 | pos2 | pos0 | pos1 | pos2 |
| <4 | | | | — | — | |
| 4 | l₀ | l₀ | | — | — | |
| 5 | l₀ | l₀ | | l₀- | l₀- | |
| 6 | l₀ | l₀ | | l₀ | l₀ | |
| 7 | l₀ | l₀ | | l₀ | l₀ | |
| 8 | l₀ | l₀ | | l₀- | l₀, 5- | |
| 9 | l₀ | l₀ | | l₀- | l₀, 5- | |
| 10 | l₀ | l₀, 8 | | l₀- | l₀, 7- | |
| 11 | l₀ | l₀, 8 | | l₀- | l₀, 7- | |
| 12 | l₀ | l₀, 8 | | l₀- | l₀, 8- | |
| 13 | l₀ | l₀, 10 | | l₀- | l₀, 8- | |
| 14 | l₀ | l₀, 10 | | — | — | |

FIG. 11 is an illustration of how parameters for PDSCH DM-RS configuration type 1 as currently defined in Table 7.4.1.1.2-2 in TS 38.211 can be updated to support TD-OCC over up to four (consecutive and/or non-consecutive) OFDM symbols for the same CDM group.

### 1.3.2 Sub-Length Orthogonal TD-OCC Over Additional DMRS Symbols

In this embodiment, separate A-TD-OCC factors wₜₐ(lₐ) are used to apply OCC codes over the additional DMRS symbols, independently of the TD-OCC factors wₜ(l′) used to apply OCC codes over the consecutive DMRS symbols. It can, however, be reformulated in terms of a joint TD-OCC factor w_{td} (l_{td}) for consecutive and additional DMRS symbols as described in Section 1.1 above.

In Table 6, an example is given of OCC code definitions giving a doubling of the number of ports. As can be seen in Table 6 this example utilizes two different A-TD-OCC vectors

$${\overline{w}}_{ta , 0} = {[ + 1 , + 1 , + 1 , + 1 ]}^{T}$$

$${\overline{w}}_{ta , 1} = {[ + 1 , - 1 , + 1 , - 1 ]}^{T}$$

where the vectors should be shortened depending on the number of additional DMRS symbols to consist of the N_{add}+1 first components.

Note that in the case of two additional DMRS the A-TD-OCC vectors w̅_{ta,0} and w̅_{ta,1} are not orthogonal over the full length three elements lₐϵ{0,1,2} but only over the two sub-lengths of two lₐϵ{0,1} and lₐϵ{1,2}. The length three vectors w̅_{ta,0} and w̅_{ta,1} are thus formally not OCC vectors, but the length two vectors consisting of the element lₐϵ{0,1} or lₐϵ{1,2} are OCC vectors and can be used to separate ports.

Note also that in the case of three additional DMRS the w̅_{ta,0} and w_{ta,1} are orthogonal over the full length of four lₐϵ{0,1,2,3} as well as over the three sub-lengths of two lₐϵ{0,1}, lₐϵ{1,2}, lₐϵ{2,3}.

The dimensionality of the A-TD-OCC vectors w̅ₜₐ is one plus the number of additional DMRS symbols (N_{add}+1). However, in this example we only use two orthogonal A-TD-OCC vectors w̅_{ta,0} and w_{ta,1} even for the case of three or four additional DMRS. This gives a doubling of the number of ports rather than giving the maximum factor three or four more ports that is possible, using the full dimensionality of the A-TD-OCC vectors. This, does, however give some other benefits as shown by the following embodiments for receiver processing.

In one embodiment for the case of three additional DMRS symbols, the receiver applies the OCC's and construct channel estimates for two different times, one based on symbols lₐϵ{0,1} and one based on lₐϵ{1,2}. From these channel estimates, channel estimates for all symbol positions are calculated based on interpolation and extrapolation in time.

In one embodiment for the case of four additional DMRS symbols, the receiver applies the OCC's and construct channel estimates for three different times, one based on symbols lₐϵ{0,1}, one based on symbols lₐϵ{1,2} and one based on symbols lₐϵ{2,3}. From these channel estimates, channel estimates for all symbol positions are calculated based on interpolation and extrapolation in time.

In one embodiment for the case of four additional DMRS symbols, the receiver applies the OCC's and construct channel estimates for three different times, one based on symbols lₐϵ{0,1} and one based on symbols lₐϵ{2,3}. From these channel estimates, channel estimates for all symbol positions are calculated based on interpolation and extrapolation in time.

TABLE 6
Example of A-TD-OCC codes over additional DMRS symbols resulting
in a doubling of the number of ports. Note that the table is applicable
both to the case of no consecutive DMRS ports (l′ = 0 only) and to the
case of no additional DMRS (lₐ = 0 only). In both these cases the
numbers of ports is 8, and only the first 8 rows in the table are used.

| | CDM | | w_{f}(k′) | | wₜ(l′) | | wₜₐ(lₐ) | | | |
|---|---|---|---|---|---|---|---|---|---|---|
| | group | | k′ = | k′ = | l′ = | l′ = | lₐ = | lₐ = | lₐ = | lₐ = |
| p | λ | Δ | 0 | 1 | 0 | 0 | 0 | 1 | 2 | 3 |
| 1000 | 0 | 0 | +1 | +1 | +1 | +1 | +1 | +1 | +1 | +1 |
| 1001 | 0 | 0 | +1 | −1 | +1 | +1 | +1 | +1 | +1 | +1 |
| 1002 | 1 | 1 | +1 | +1 | +1 | +1 | +1 | +1 | +1 | +1 |
| 1003 | 1 | 1 | +1 | −1 | +1 | +1 | +1 | +1 | +1 | +1 |
| 1004 | 0 | 0 | +1 | +1 | +1 | −1 | +1 | −1 | +1 | −1 |
| 1005 | 0 | 0 | +1 | −1 | +1 | −1 | +1 | −1 | +1 | −1 |
| 1006 | 1 | 1 | +1 | +1 | +1 | −1 | +1 | −1 | +1 | −1 |
| 1007 | 1 | 1 | +1 | −1 | +1 | −1 | +1 | −1 | +1 | −1 |
| 1008 | 0 | 0 | +1 | +1 | +1 | +1 | +1 | −1 | +1 | −1 |
| 1009 | 0 | 0 | +1 | −1 | +1 | +1 | +1 | −1 | +1 | −1 |
| 1010 | 1 | 1 | +1 | +1 | +1 | +1 | +1 | −1 | +1 | −1 |
| 1011 | 1 | 1 | +1 | −1 | +1 | +1 | +1 | −1 | +1 | −1 |
| 1012 | 0 | 0 | +1 | +1 | +1 | −1 | +1 | +1 | +1 | +1 |
| 1013 | 0 | 0 | +1 | −1 | +1 | −1 | +1 | +1 | +1 | +1 |
| 1014 | 1 | 1 | +1 | +1 | +1 | −1 | +1 | +1 | +1 | +1 |
| 1015 | 1 | 1 | +1 | −1 | +1 | −1 | +1 | +1 | +1 | +1 |

### 1.3.3 DFT-Code-Based TD-OCC Over Additional DMRS Symbols

In this embodiment, separate A-TD-OCC factors wₜₐ(lₐ) are used to apply OCC codes over the additional DMRS symbols, independently of the TD-OCC factors wₜ(l′) used to apply OCC codes over the consecutive DMRS symbols. It can, however, be reformulated in terms of a joint TD-OCC factor w_{td} (l_{td}) for consecutive and additional DMRS symbols as described in Section 1.1 above.

The A-TD-OCC factors wₜₐ(lₐ) constitute the elements of A-TD-OCC vectors (or equivalently A-TD-OCC codes) w̅ₜₐ. Different A-TD-OCC vectors are used for different ports.

In Table 7, we give the A-TD-OCC codes for the case of three additional DMRS symbols, using A-TD-OCC codes that are orthogonal over the full length of three additional symbols to double the number of ports (using the first 16 rows in Table 7) or to triple the number of ports (using the full Table 7). The A-TD-OCC vectors used for additional DMRS symbols are

$${\overline{w}}_{ta , 0} = {[ + 1 , + 1 , + 1 , ]}^{T}$$

$${\overline{w}}_{ta , 1} = {[ + 1 , {e}^{i \frac{2 π}{3}} , {e}^{i \frac{4 π}{3}} , ]}^{T}$$

$${\overline{w}}_{ta , 2} = {[ + 1 , {e}^{i \frac{4 π}{3}} , {e}^{i \frac{8 π}{3}} , ]}^{T} = {[ + 1 , {e}^{i \frac{4 π}{3}} , {e}^{i \frac{2 π}{3}} , ]}^{T}$$

which may be viewed as cyclic shift or DFT codes. In the first 16 rows only the first two A-TD-OCC vectors w̅_{ta,0} and w̅_{ta,1} are used.

TABLE 7
Example A-TD-OCC codes for three additional DMRS symbols resulting in a doubling
of the number of ports. Note that the table is applicable also to the case of no consecutive DMRS
ports (l_{c} = 0 only) in which case the numbers of ports is 8, and only the first 8 rows in the table
are used.

| | CDM group | | w_{f}(k′) | | wₜ(l′) | | wₜₐ(la) | | |
|---|---|---|---|---|---|---|---|---|---|
| P | λ | Δ | k′ = 0 | k′ = 1 | l′ = 0 | l′ = 0 | lₐ = 0 | lₐ = 1 | lₐ = 2 |
| 1000 | 0 | 0 | +1 | +1 | +1 | +1 | +1 | +1 | +1 |
| 1001 | 0 | 0 | +1 | −1 | +1 | +1 | +1 | +1 | +1 |
| 1002 | 1 | 1 | +1 | +1 | +1 | +1 | +1 | +1 | +1 |
| 1003 | 1 | 1 | +1 | −1 | +1 | +1 | +1 | +1 | +1 |
| 1004 | 0 | 0 | +1 | +1 | +1 | −1 | +1 | ${e}^{i \frac{2 π}{3}}$ | ${e}^{i \frac{4 π}{3}}$ |
| 1005 | 0 | 0 | +1 | −1 | +1 | −1 | +1 | ${e}^{i \frac{2 π}{3}}$ | ${e}^{i \frac{4 π}{3}}$ |
| 1006 | 1 | 1 | +1 | +1 | +1 | −1 | +1 | ${e}^{i \frac{2 π}{3}}$ | ${e}^{i \frac{4 π}{3}}$ |
| 1007 | 1 | 1 | +1 | −1 | +1 | −1 | +1 | ${e}^{i \frac{2 π}{3}}$ | ${e}^{i \frac{4 π}{3}}$ |
| 1008 | 0 | 0 | +1 | +1 | +1 | +1 | +1 | ${e}^{i \frac{2 π}{3}}$ | ${e}^{i \frac{4 π}{3}}$ |
| 1009 | 0 | 0 | +1 | −1 | +1 | +1 | +1 | ${e}^{i \frac{2 π}{3}}$ | ${e}^{i \frac{4 π}{3}}$ |
| 1010 | 1 | 1 | +1 | +1 | +1 | +1 | +1 | ${e}^{i \frac{2 π}{3}}$ | ${e}^{i \frac{4 π}{3}}$ |
| 1011 | 1 | 1 | +1 | −1 | +1 | +1 | +1 | ${e}^{i \frac{2 π}{3}}$ | ${e}^{i \frac{4 π}{3}}$ |
| 1012 | 0 | 0 | +1 | +1 | +1 | −1 | +1 | +1 | +1 |
| 1013 | 0 | 0 | +1 | −1 | +1 | −1 | +1 | +1 | +1 |
| 1014 | 1 | 1 | +1 | +1 | +1 | −1 | +1 | +1 | +1 |
| 1015 | 1 | 1 | +1 | −1 | +1 | −1 | +1 | +1 | +1 |
| 1016 | 0 | 0 | +1 | +1 | +1 | −1 | +1 | ${e}^{i \frac{4 π}{3}}$ | ${e}^{i \frac{2 π}{3}}$ |
| 1017 | 0 | 0 | +1 | −1 | +1 | −1 | +1 | ${e}^{i \frac{4 π}{3}}$ | ${e}^{i \frac{2 π}{3}}$ |
| 1018 | 1 | 1 | +1 | +1 | +1 | −1 | +1 | ${e}^{i \frac{4 π}{3}}$ | ${e}^{i \frac{2 π}{3}}$ |
| 1019 | 1 | 1 | +1 | −1 | +1 | −1 | +1 | ${e}^{i \frac{4 π}{3}}$ | ${e}^{i \frac{2 π}{3}}$ |
| 1020 | 0 | 0 | +1 | +1 | +1 | +1 | +1 | ${e}^{i \frac{4 π}{3}}$ | ${e}^{i \frac{2 π}{3}}$ |
| 1021 | 0 | 0 | +1 | −1 | +1 | +1 | +1 | ${e}^{i \frac{4 π}{3}}$ | ${e}^{i \frac{2 π}{3}}$ |
| 1022 | 1 | 1 | +1 | +1 | +1 | +1 | +1 | ${e}^{i \frac{4 π}{3}}$ | ${e}^{i \frac{2 π}{3}}$ |
| 1023 | 1 | 1 | +1 | −1 | +1 | +1 | +1 | ${e}^{i \frac{4 π}{3}}$ | ${e}^{i \frac{2 π}{3}}$ |

### 1.4 TD-OCC Over Additional DMRS Symbols Coupled to FD-OCC for Robustness Against Delay Spread

In one embodiment, TD-OCC over additional DMRS symbols is coupled to FD-OCC in such a way that the receiver can choose between using FD-OCC and TDD-OCC over additional DMRS symbols for port separation. The receiver can thus choose between robustness against doppler spread (FD-OCC) or robustness against delay spread (TD-OCC over additional DMRS symbols). In one embodiment, the choice between the two alternatives is made based on estimates of doppler spread and delay spread.

In one embodiment, TD-OCC over additional DMRS symbols is coupled to FD-OCC in such a way that the receiver can choose between using
Alt 1. Full length FD-OCC, or
Alt 2. Sub-length FD OCC together with TD-OCC over additional DMRS

for port separation. The receiver can thus choose between robustness against doppler spread (alt 1) or robustness against delay spread (alt 2). In another embodiment, separate A-TD-OCC factors wₜₐ(lₐ) are used to apply OCC codes over the additional DMRS symbols, independently of the TD-OCC factors wₜ(l′) used to apply OCC codes over the consecutive DMRS symbols. It can, however, be reformulated in terms of a joint TD-OCC factor w_{td} (l_{td}) for consecutive and additional DMRS symbols as described in Section 1.1. The formulation with separate A-TD-OCC for additional DMRS symbols and TD-OCC factors for adjacent DMRS symbols is, however, useful when discussing the properties of OCC vectors and mappings of ports to OCC vectors in the subsections below. Either formulation may, however, be used to specify the described methods.

Note that the explicitly described embodiments are for “DMRS Type 1”, however, they can easily be extended to “DMRS Type 2” in a similar way.

### 1.4.1 Sub-Length Orthogonal TD-OCC Over Additional DMRS Symbols Coupled to Length-2 FD-OCC

In Table 8, an example is given of A-TD-OCC codes over additional DMRS symbols that give no increase in the number of ports but instead give increased resistance to delay spread. The of A-TD-OCC vectors have been chosen so that w_{f}(k′) and wₜₐ(lₐ) separate the same ports, i.e.

$$\begin{matrix}{\overline{w}}_{f , {g}_{f} ( {p}_{1} )} = {\overline{w}}_{f , {g}_{f} ( {p}_{2} )} ⇔ {\overline{w}}_{ta , {g}_{ta} ( {p}_{1} )} = {\overline{w}}_{ta , {g}_{ta} ( {p}_{2} )} \\ {\overline{w}}_{f , {g}_{f} ( {p}_{1} )} \neq {\overline{w}}_{f , {g}_{f} ( {p}_{2} )} ⇔ {\overline{w}}_{ta , {g}_{ta} ( {p}_{1} )} \neq {\overline{w}}_{ta , {g}_{ta} ( {p}_{2} )}\end{matrix}$$

where w̅_{f,g}_{_{f}}₍ₚ₎ is the FD-OCC vector with elements w̅_{f}(k′) for port p, and w̅_{ta,gt}_{ₐ}₍ₚ₎ is the A-TD-OCC vector for additional DMRS symbols with elements wₜₐ(k′) for port p. In case of large delay spread the receiver can thus use wₜₐ (lₐ) to separate ports, while in case of large doppler spread the receiver can use w_{f} (k′) to separate ports.

To be specific, two A-TD-OCC vectors are used in Table 8:

$${\overline{w}}_{ta , 0} = {[ + 1 , + 1 , + 1 , + 1 ]}^{T}$$

$${\overline{w}}_{ta , 1} = {[ + 1 , - 1 , + 1 , - 1 ]}^{T}$$

Here the vectors should be shortened depending on the number of additional DMRS symbols to consist of the N_{add}+1 first components.

Similarly, two FD-OCC vectors are used in Table 8:

$${\overline{w}}_{f , 0} = {[ + 1 , + 1 , ]}^{T}$$

$${\overline{w}}_{f , 1} = {[ + 1 , - 1 ]}^{T}$$

Based on the above numbering of OCC vectors the mapping functions for A-TD-OCC and FD-OCC as given implicitly by Table 8 are identical:

$${g}_{f} ( p ) = {g}_{ta} ( p ) ∀ p$$

And, thus, the same ports are separated by A-TD-OCC and FD-OCC.

The receiver can thus choose between using A-TD-OCC and FD-OCC to separate ports. In one embodiment the receiver makes this choice based on at least estimates of delay spread and doppler spread.

Note that in the case of three additional DMRS the A-TD-OCC vectors w̅_{ta,0} and w̅_{ta,1} are not orthogonal over the full length three elements lₐϵ{0,1,2} but only over the two sub-lengths of two lₐϵ{0,1} and lₐϵ{1,3}. The length three vectors w̅_{ta,0} and w̅_{ta,1} are thus formally not OCC vectors, but the length two vectors consisting of the element lₐϵ{0,1} or lₐϵ{1,3} are OCC vectors and can be used to separate ports.

Note also that in the case of four additional DMRS the w̅_{ta,0} and w̅_{ta,1} are orthogonal over the full length of four lₐϵ{0,1,2,3} as well as over the three sub-lengths of two lₐϵ{0,1}, lₐϵ{1,2}, lₐϵ{2,3}. In this case the receiver has a choice between three alternatives:
1. Use FD-OCC for port separation (and don't use TD-OCC over additional DMRS symbols for port separation)
2. Use TD-OCC over the three sub-lengths of two lₐϵ{0,1}, lₐϵ{1,2}, lₐϵ{2,3} for port separation (and don't use FD-OCC for port separation)
3. Use TD-OCC over the full length of four lₐϵ{0,1,2,3} for port separation (and don't use FD-OCC for port separation)

The third alternative is more susceptible to doppler spread than the second alternative but less susceptible to noise and interference due to the larger processing gain from the use of more symbols.

In one embodiment, the receiver selects one of these alternatives based on estimates of delay spread, doppler spread and SINR.

In one embodiment for the case of three additional DMRS symbols, the receiver applies the OCC's and construct channel estimates for two different times, one based on symbols lₐϵ{0,1} and one based on lₐϵ{1,2}. From these channel estimates, channel estimates for all symbol positions are calculated based on interpolation and extrapolation in time.

In one embodiment for the case of four additional DMRS symbols, the receiver applies the OCC's and construct channel estimates for three different times, one based on symbols lₐϵ{0,1}, one based on symbols lₐϵ{1,2} and one based on symbols lₐϵ{2,3}. From these channel estimates, channel estimates for all symbol positions are calculated based on interpolation and extrapolation in time.

In one embodiment for the case of four additional DMRS symbols, the receiver applies the OCC's and construct channel estimates for three different times, one based on symbols lₐϵ{0,1} and one based on symbols lₐϵ{2,3}. From these channel estimates, channel estimates for all symbol positions are calculated based on interpolation and extrapolation in time.

TABLE 8
Example TD-OCC codes over additional DMRS symbols that give
no increase in the number of ports but instead give increased
resistance to delay spread. The OCC vectors have been chosen so
that w_{f}(k′) and wₜₐ(lₐ) separate the same ports. In case of large
delay spread the receiver can thus use wₜₐ(lₐ) to separate ports,
while in case of large doppler spread the receiver can use
w_{f}(k′) to separate ports.

| | CDM | | w_{f}(k′) | | wₜ(l′) | | wₜₐ(lₐ) | | | |
|---|---|---|---|---|---|---|---|---|---|---|
| | group | | k′ = | k′ = | l′ = | l′ = | lₐ = | lₐ = | lₐ = | lₐ = |
| p | λ | Δ | 0 | 1 | 0 | 0 | 0 | 1 | 2 | 3 |
| 1000 | 0 | 0 | +1 | +1 | +1 | +1 | +1 | +1 | +1 | +1 |
| 1001 | 0 | 0 | +1 | −1 | +1 | +1 | +1 | −1 | +1 | −1 |
| 1002 | 1 | 1 | +1 | +1 | +1 | +1 | +1 | +1 | +1 | +1 |
| 1003 | 1 | 1 | +1 | −1 | +1 | +1 | +1 | −1 | +1 | −1 |
| 1004 | 0 | 0 | +1 | +1 | +1 | −1 | +1 | +1 | +1 | +1 |
| 1005 | 0 | 0 | +1 | −1 | +1 | −1 | +1 | −1 | +1 | −1 |
| 1006 | 1 | 1 | +1 | +1 | +1 | −1 | +1 | +1 | +1 | +1 |
| 1007 | 1 | 1 | +1 | −1 | +1 | −1 | +1 | −1 | +1 | −1 |

### 1.4.2 Sub-Length Orthogonal TD-OCC Over Additional DMRS Symbols Coupled to Length-4 FD-OCC

In Table 9, an example is given where longer FD-OCC codes have been used to double the number of ports while A-TD-OCC codes over additional DMRS symbols are applied in such a way that they give no additional increase in number of ports beyond what is given by the FD-OCC but instead give increased resistance to delay spread. Here we use four of the six length six cyclic shift codes for FD-OCC:

$${w}_{f , 0}^{T} = [ {w}_{0 , 1} , {w}_{0 , 2} , {w}_{0 , 3} , {w}_{0 , 4} , {w}_{0 , 5} , {w}_{0 , 6} ] = [ + 1 , \\ exp ( j π / 3 ) , exp ( j 2 π / 3 ) , - 1 , exp ( j 4 π / 3 ) , exp ( j 5 π / 3 ) ] ]$$

$${w}_{f , 1}^{T} = [ {w}_{1 , 1} , {w}_{1 , 2} , {w}_{1 , 3} , {w}_{1 , 4} , {w}_{1 , 5} , {w}_{1 , 6} ] = [ + 1 , \\ exp ( j 2 π / 3 ) , exp ( j 4 π / 3 ) , + 1 , exp ( j 8 π / 3 ) , exp ( j 10 π / 3 ) ]$$

$${w}_{f , 2}^{T} = [ {w}_{2 , 1} , {w}_{2 , 2} , {w}_{2 , 3} , {w}_{2 , 4} , {w}_{2 , 5} , {w}_{2 , 6} ] = + 1 , \\ exp ( j 4 π / 3 ) , exp ( j 8 π / 3 ) , + 1 , exp ( j 16 π / 3 ) , exp ( j 20 π / 3 ) ]$$

$${w}_{f , 3}^{T} = [ {w}_{3 , 1} , {w}_{3 , 2} , {w}_{3 , 3} , {w}_{3 , 4} , {w}_{3 , 5} , {w}_{3 , 6} ] = [ + 1 , \\ exp ( j 5 π / 3 ) , exp ( j 10 π / 3 ) , - 1 , exp ( j 20 π / 3 ) , exp ( j 25 π / 3 ) ]$$

The FD-OCC vectors are of course all orthogonal over the full length 6. In addition, the FD-OCC vectors w_{f,0} and w_{f,2} are orthogonal over any cyclic length two interval, i.e. k′ϵ{0,1}, k′ϵ{1,2}, k′ϵ{2,3}, k′ϵ{3,4}, k′ϵ{4,5}, and k′ϵ{5,0}. The same holds for w_{f,1} and w_{f,3}.

We note that separation of w_{f,0} and w_{f,2} or w_{f,1} and w_{f,3}. is thus significantly less susceptible to delay spread than the general case (e.g., separation of w_{f,0} and w_{f,1}).

In Table 9, for TD-OCC over additional DMRS symbols, we use only the two vectors

$${w}_{ta , 0}^{T} = [ + 1 , + 1 , + 1 , + 1 ]$$

$${w}_{ta , 1}^{T} = [ + 1 , - 1 , + 1 , - 1 ]$$

We use w_{ta,0} together with w_{f,0} and w_{f,2} and we use w_{ta,1} together with w_{f,1} and w_{f,3}.

In case of large delay spread the receiver can thus utilize A-TD-OCC for additional DMRS symbols to separate the two FD-OCC vector groups {w_{f,0}, w_{f,2}} and {w_{f,1}, w_{f,3}} from each other and use length-2 FD-OCC to separate w_{f,0} from w_{f,2} and w_{f,1} and w_{f,3}. In other words, the receiver use length-2 FD-OCC together with length-2 TD-OCC over additional DMRS symbols to separate the ports.

In case of large Doppler spread the receiver can instead utilize the full length six FD-OCC codes to separate ports and refrain from using A-TD-OCC for additional DMRS symbols.

In one embodiment, the receiver makes this choice between these two alternatives based on at least estimates of delay spread and doppler spread.

In the case of four additional DMRS the w_{ta,0} and w_{ta,1} are orthogonal over the full length of four lₐϵ{0,1,2,3} as well as over the three sub-lengths of two lₐϵ{0,1}, lₐϵ{1,2}, lₐϵ{2,3}. In this case the receiver has a choice between three alternatives:
1. Use full length-6 FD-OCC for port separation (and don't use TD-OCC over additional DMRS symbols for port separation)
2. Use length-2 FD-OCC together with A-TD-OCC over the three sub-lengths of two lₐϵ{0,1}, lₐϵ{1,2}, lₐϵ{2,3} for port separation
3. Use length-2 FD-OCC together with TD-OCC over the full length of four lₐϵ{0,1,2,3} for port separation (and don't use FD-OCC for port separation)

The third alternative is more susceptible to doppler spread than the second alternative but less susceptible to noise and interference due to the larger processing gain from the use of more symbols.

In one embodiment, the receiver selects one of these alternatives based on estimates of delay spread, doppler spread and SINR.

TABLE 9

| | CDM | | | | | | | | | | | | | |
|---|---|---|---|---|---|---|---|---|---|---|---|---|---|---|
| | group | | w_{f}(k′) | | | | | | wₜ(l′) | | wₜₐ(lₐ) | | | |
| p | λ | Δ | k′ = 0 | k′ = 1 | k′ = 2 | k′ = 3 | k′ = 4 | k′ = 5 | l′ = 0 | l′ = 1 | lₐ = 0 | lₐ = 1 | lₐ = 2 | lₐ = 3 |
| 1000 | 0 | 0 | w_{0, 1} | w_{0, 2} | w_{0, 3} | w_{0, 4} | w_{0, 5} | w_{0, 6} | +1 | +1 | +1 | +1 | +1 | +1 |
| 1001 | 0 | 0 | w_{1, 1} | w_{1, 2} | w_{1, 3} | w_{1, 4} | w_{1, 5} | w_{1, 6} | +1 | +1 | +1 | −1 | +1 | −1 |
| 1002 | 0 | 0 | w_{2, 1} | w_{2, 2} | w_{2, 3} | w_{2, 4} | w_{2, 5} | w_{2, 6} | +1 | +1 | +1 | +1 | +1 | +1 |
| 1003 | 0 | 0 | w_{3, 1} | w_{3, 2} | w_{3, 3} | w_{3, 4} | w_{3, 5} | w_{3, 6} | +1 | +1 | +1 | −1 | +1 | −1 |
| 1004 | 1 | 1 | w_{0, 1} | w_{0, 2} | w_{0, 3} | w_{0, 4} | w_{0, 5} | w_{0, 6} | +1 | +1 | +1 | +1 | +1 | +1 |
| 1005 | 1 | 1 | w_{1, 1} | w_{1, 2} | w_{1, 3} | w_{1, 4} | w_{1, 5} | w_{1, 6} | +1 | +1 | +1 | −1 | +1 | −1 |
| 1006 | 1 | 1 | w_{2, 1} | w_{2, 2} | w_{2, 3} | w_{2, 4} | w_{2, 5} | w_{2, 6} | +1 | +1 | +1 | +1 | +1 | +1 |
| 1007 | 1 | 1 | w_{3, 1} | w_{3, 2} | w_{3, 3} | w_{3, 4} | w_{3, 5} | w_{3, 6} | +1 | +1 | +1 | −1 | +1 | −1 |
| 1008 | 0 | 0 | w_{0, 1} | w_{0, 2} | w_{0, 3} | w_{0, 4} | w_{0, 5} | w_{0, 6} | +1 | −1 | +1 | +1 | +1 | +1 |
| 1009 | 0 | 0 | w_{1, 1} | w_{1, 2} | w_{1, 3} | w_{1, 4} | w_{1, 5} | w_{1, 6} | +1 | −1 | +1 | −1 | +1 | −1 |
| 1010 | 0 | 0 | w_{2, 1} | w_{2, 2} | w_{2, 3} | w_{2, 4} | w_{2, 5} | w_{2, 6} | +1 | −1 | +1 | +1 | +1 | +1 |
| 1011 | 0 | 0 | w_{3, 1} | w_{3, 2} | w_{3, 3} | w_{3, 4} | w_{3, 5} | w_{3, 6} | +1 | −1 | +1 | −1 | +1 | −1 |
| 1012 | 1 | 1 | w_{0, 1} | w_{0, 2} | w_{0, 3} | w_{0, 4} | w_{0, 5} | w_{0, 6} | +1 | −1 | +1 | +1 | +1 | +1 |
| 1013 | 1 | 1 | w_{1, 1} | w_{1, 2} | w_{1, 3} | w_{1, 4} | w_{1, 5} | w_{1, 6} | +1 | −1 | +1 | −1 | +1 | −1 |
| 1014 | 1 | 1 | w_{2, 1} | w_{2, 2} | w_{2, 3} | w_{2, 4} | w_{2, 5} | w_{2, 6} | +1 | −1 | +1 | +1 | +1 | +1 |
| 1015 | 1 | 1 | w_{3, 1} | w_{3, 2} | w_{3, 3} | w_{3, 4} | w_{3, 5} | w_{3, 6} | +1 | −1 | +1 | −1 | +1 | −1 |

### 2 Signaling Embodiments

In one embodiment, the new extended/non-consecutive TD-OCC feature for DMRS is indicated to the UE by using RRC configuration. In one alternate of this embodiment, a new field is added in “DMRS-DownlinkConfig” and/or “DMRS-UplinkConfig” that indicates that the extended/non-consecutive TD-OCC feature for DMRS should be used for DL DMRS and/or UL DMRS.

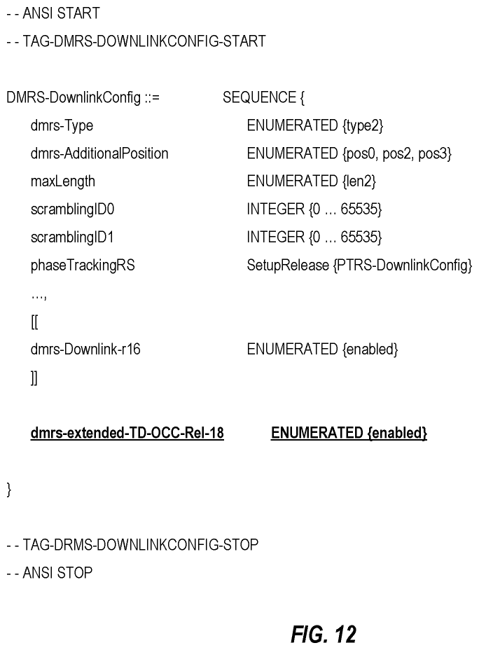

One example of how such RRC configuration can look for DL DMRS is schematically illustrated by the highlighted text in FIG. 12. When this parameter is configured, the UE should assume that the new DMRS design with extended/non-consecutive TD-OCC feature for DMRS is applied for PDSCH. This could for example mean that the UE should associated the DCI field “Antenna port(s) and number of layers” in DCI Format 1_1 to a new set of Antenna port tables instead of the Antenna port tables currently specified in tables 7.3.1.1.2-7 to 7.3.1.1.2-23 as defined in TS 38.212. It is also possible that some of the tables are re-used as they are, or that some of the tables are re-used but extended with new additional codepoints adapted to the new extended DMRS configuration.

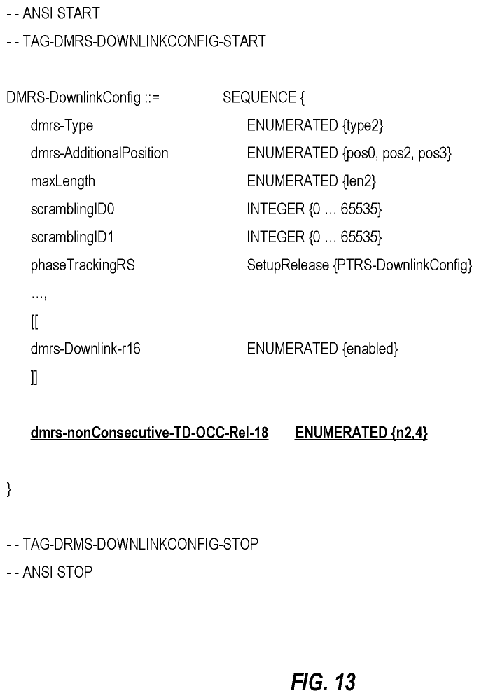

FIG. 13 illustrates another variant of this embodiment where the new RRC parameter indicates that TD-OCC over non-consecutive OFDM symbols are supported (if configured), and it indicates over how many total OFDM symbols the TD-OCC could span at maximum (2 or 4 in this example).

In one alternate of this embodiment, over how many OFDM symbols the UE at maximum can perform TD-OCC for DMRS is based on UE capability signaling.

In one embodiment, the extended/non-consecutive TD-OCC is viewed as cyclic shift (or equivalently a DFT code) and configured by higher layer configuration. Instead of supporting all different cyclic shift values dynamically, the UE can indicate to gNB in UE capability number of different CyclicShift values it is capable of supporting. In one example, a UE indicate it can support 1 cyclic shift value, and a gNB configures the cyclic shift in DMRS-DownlinkConfig, e.g. as below:
dmrs-nonConsecutive-CyclicShift-r18 ENUMERATED (0, 2/3Pi, 4/3Pi)

### 3 Further Description

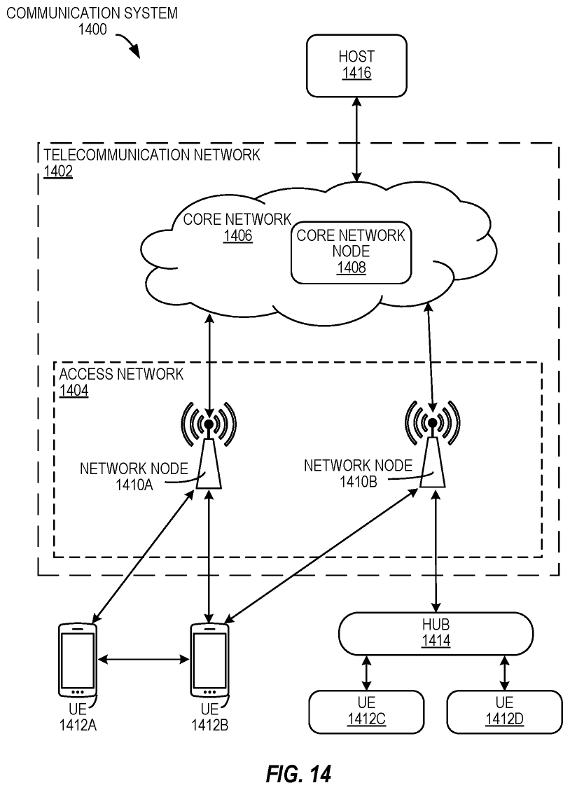

FIG. 14 shows an example of a communication system 1400 in accordance with some embodiments.

In the example, the communication system 1400 includes a telecommunication network 1402 that includes an access network 1404, such as a Radio Access Network (RAN), and a core network 1406, which includes one or more core network nodes 1408. The access network 1404 includes one or more access network nodes, such as network nodes 1410A and 1410B (one or more of which may be generally referred to as network nodes 1410), or any other similar 3GPP access node or non-3GPP Access Point (AP). The network nodes 1410 facilitate direct or indirect connection of UE, such as by connecting UEs 1412A, 1412B, 1412C, and 1412D (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system 1400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1402 is a cellular network that implements 3GPP standardized features. Accordingly, the telecommunication network 1402 may support network slicing to provide different logical networks to different devices that are connected to the telecommunication network 1402. For example, the telecommunication network 1402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-Radio Access Technology (RAT) or multi-standard mode. For example, a UE may operate with any one or combination of WiFi, NR, and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1414 communicates with the access network 1404 to facilitate indirect communication between one or more UEs (e.g., UE 1412C and/or 1412D) and network nodes (e.g., network node 1410B). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a Virtual Reality (VR) headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410B. The hub 1414 may also allow for a different communication scheme and/or schedule between the hub 1414 and UEs (e.g., UE 1412C and/or 1412D), and between the hub 1414 and the core network 1406. In other examples, the hub 1414 is connected to the core network 1406 and/or one or more UEs via a wired connection. Moreover, the hub 1414 may be configured to connect to a Machine-to-Machine (M2M) service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410B. In other embodiments, the hub 1414 may be a non-dedicated hub—that is, a device which is capable of operating to route communications between the UEs and the network node 1410B, but which is additionally capable of operating as a communication start and/or end point for certain data channels.

FIG. 15 shows a UE 1500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1502 may include multiple Central Processing Units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging the power source 1508. Power circuitry may perform any formatting, converting, or other modification to the power from the power source 1508 to make the power suitable for the respective components of the UE 1500 to which power is supplied.

The memory 1510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1510 may allow the UE 1500 to access instructions, application programs, and the like stored on transitory or non-transitory memory media, to off-load data, or to upload data. An article of manufacture, such as one utilizing a communication system, may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., the antenna 1522) and may share circuit components, software, or firmware, or alternatively be implemented separately.

In the illustrated embodiment, communication functions of the communication interface 1512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

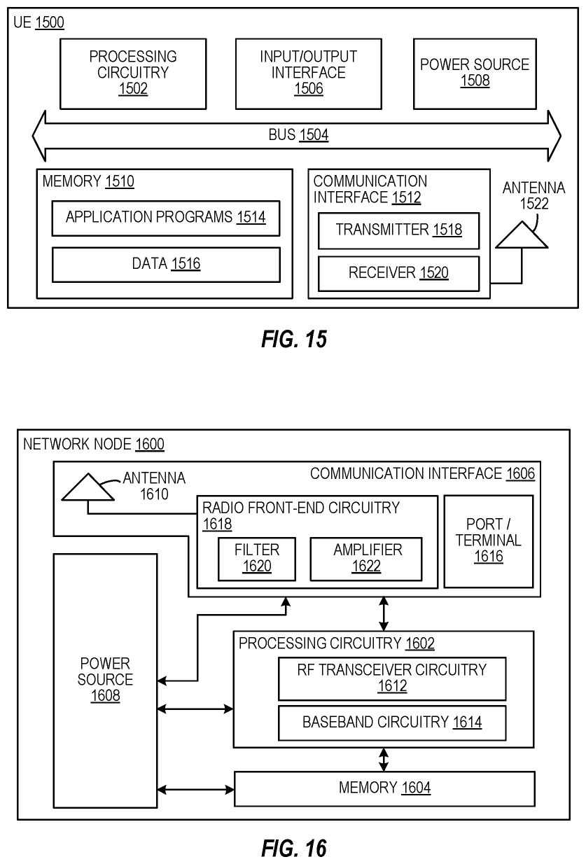

FIG. 16 shows a network node 1600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes processing circuitry 1602, memory 1604, a communication interface 1606, and a power source 1608. The network node 1600 may be composed of multiple physically separate components (e.g., a Node B component and an RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1600 may be configured to support multiple RATs. In such embodiments, some components may be duplicated (e.g., separate memory 1604 for different RATs) and some components may be reused (e.g., an antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1600.

The processing circuitry 1602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1600 components, such as the memory 1604, to provide network node 1600 functionality.

In some embodiments, the processing circuitry 1602 includes a System on a Chip (SOC). In some embodiments, the processing circuitry 1602 includes one or more of Radio Frequency (RF) transceiver circuitry 1612 and baseband processing circuitry 1614. In some embodiments, the RF transceiver circuitry 1612 and the baseband processing circuitry 1614 may be on separate chips (or sets of chips), boards, or units, such as radio units and digital units. In alternative embodiments, part or all of the RF transceiver circuitry 1612 and the baseband processing circuitry 1614 may be on the same chip or set of chips, boards, or units.

The memory 1604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and the memory 1604 are integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. The radio front-end circuitry 1618 comprises filters 1620 and amplifiers 1622. The radio front-end circuitry 1618 may be connected to the antenna 1610 and the processing circuitry 1602. The radio front-end circuitry 1618 may be configured to condition signals communicated between the antenna 1610 and the processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of the filters 1620 and/or the amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface 1606 may comprise different components and/or different combinations of components.

In certain alternative embodiments, the network node 1600 does not include separate radio front-end circuitry 1618; instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes the one or more ports or terminals 1616, the radio front-end circuitry 1618, and the RF transceiver circuitry 1612 as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, the communication interface 1606, and/or the processing circuitry 1602 may be configured to perform any receiving operations and/or certain obtaining operations described herein as being performed by the network node 1600. Any information, data, and/or signals may be received from a UE, another network node, and/or any other network equipment. Similarly, the antenna 1610, the communication interface 1606, and/or the processing circuitry 1602 may be configured to perform any transmitting operations described herein as being performed by the network node 1600. Any information, data, and/or signals may be transmitted to a UE, another network node, and/or any other network equipment.

The power source 1608 provides power to the various components of the network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid or an electricity outlet) via input circuitry or an interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

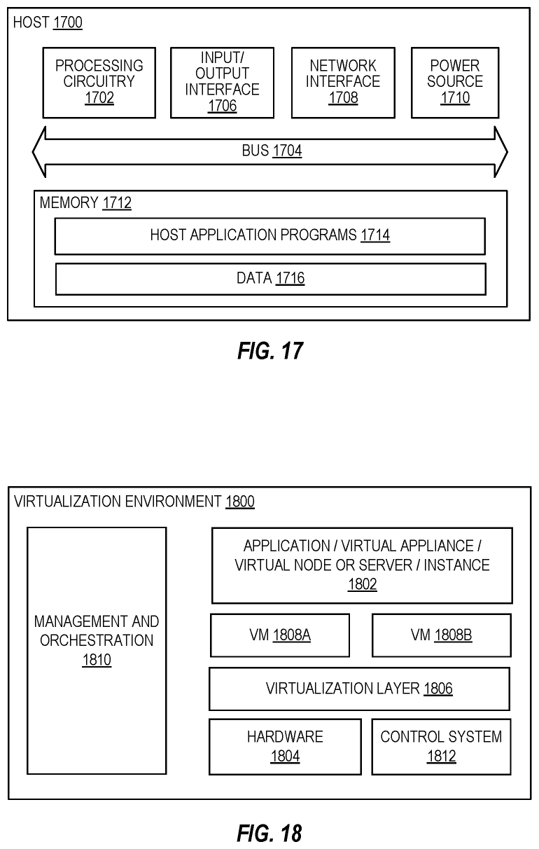

FIG. 17 is a block diagram of a host 1700, which may be an embodiment of the host 1416 of FIG. 14, in accordance with various aspects described herein. As used herein, the host 1700 may be or comprise various combinations of hardware and/or software including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of the host 1700.

The memory 1712 may include one or more computer programs including one or more host application programs 1714 and data 1716, which may include user data, e.g. data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for Over-The-Top (OTT) services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or VM Monitors (VMMs)), provide VMs 1808A and 1808B (one or more of which may be generally referred to as VMs 1808), and/or perform any of the functions, features, and/or benefits described in relation with some embodiments described herein. The virtualization layer 1806 may present a virtual operating platform that appears like networking hardware to the VMs 1808.

The VMs 1808 comprise virtual processing, virtual memory, virtual networking, or interface and virtual storage, and may be run by a corresponding virtualization layer 1806. Different embodiments of the instance of a virtual appliance 1802 may be implemented on one or more of the VMs 1808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1808 may be a software implementation of a physical machine that runs programs as if they were executing on a physical, non-virtualized machine. Each of the VMs 1808, and that part of the hardware 1804 that executes that VM, be it hardware dedicated to that VM and/or hardware shared by that VM with others of the VMs 1808, forms separate virtual network elements. Still in the context of NFV, a virtual network function is responsible for handling specific network functions that run in one or more VMs 1808 on top of the hardware 1804 and corresponds to the application 1802.

The hardware 1804 may be implemented in a standalone network node with generic or specific components. The hardware 1804 may implement some functions via virtualization. Alternatively, the hardware 1804 may be part of a larger cluster of hardware (e.g., such as in a data center or CPE) where many hardware nodes work together and are managed via management and orchestration 1810, which, among others, oversees lifecycle management of the applications 1802. In some embodiments, the hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1812 which may alternatively be used for communication between hardware nodes and radio units.

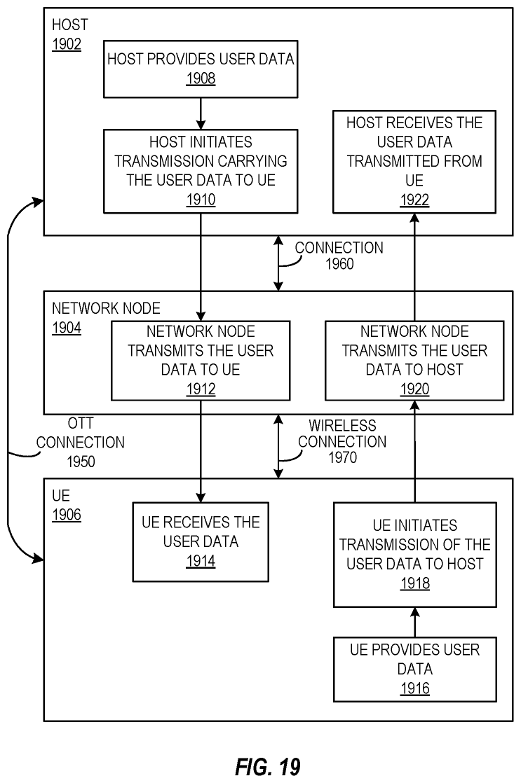

FIG. 19 shows a communication diagram of a host 1902 communicating via a network node 1904 with a UE 1906 over a partially wireless connection in accordance with some embodiments. Example implementations, in accordance with various embodiments, of the UE (such as the UE 1412A of FIG. 14 and/or the UE 1500 of FIG. 15), the network node (such as the network node 1410A of FIG. 14 and/or the network node 1600 of FIG. 16), and the host (such as the host 1416 of FIG. 14 and/or the host 1700 of FIG. 17) discussed in the preceding paragraphs will now be described with reference to FIG. 19.

Like the host 1700, embodiments of the host 1902 include hardware, such as a communication interface, processing circuitry, and memory. The host 1902 also includes software, which is stored in or is accessible by the host 1902 and executable by the processing circuitry. The software includes a host application that may be operable to provide a service to a remote user, such as the UE 1906 connecting via an OTT connection 1950 extending between the UE 1906 and the host 1902. In providing the service to the remote user, a host application may provide user data which is transmitted using the OTT connection 1950.

The network node 1904 includes hardware enabling it to communicate with the host 1902 and the UE 1906 via a connection 1960. The connection 1960 may be direct or pass through a core network (like the core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by the UE 1906 and executable by the UE's processing circuitry. The software includes a client application, such as a web browser or operator-specific “app” that may be operable to provide a service to a human or non-human user via the UE 1906 with the support of the host 1902. In the host 1902, an executing host application may communicate with the executing client application via the OTT connection 1950 terminating at the UE 1906 and the host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via the connection 1960 between the host 1902 and the network node 1904 and via a wireless connection 1970 between the network node 1904 and the UE 1906 to provide the connection between the host 1902 and the UE 1906. The connection 1960 and the wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904 in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR, or AR which it can broadcast, multicast, or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1950 between the host 1902 and the UE 1906 in response to variations in the measurement results. The measurement procedure and/or the network functionality for reconfiguring the OTT connection 1950 may be implemented in software and hardware of the host 1902 and/or the UE 1906. In some embodiments, sensors (not shown) may be deployed in or in association with other devices through which the OTT connection 1950 passes; the sensors may participate in the measurement procedure by supplying values of the monitored quantities exemplified above, or by supplying values of other physical quantities from which software may compute or estimate the monitored quantities. The reconfiguring of the OTT connection 1950 may include message format, retransmission settings, preferred routing, etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency, and the like by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

1. A method performed by a radio node, the method comprising:
estimating channel characteristics or receiving channel characteristics through signaling; and
depending on the channel characteristics, performing Demodulation Reference Signal, DMRS, Orthogonal Cover Code, OCC, decoding based on either: (a) sub-length orthogonal Frequency Domain OCC, FD-OCC, combined with sub-length orthogonal Time Domain OCC, TD-OCC, over one or more additional DMRS symbols or (b) FD-OCC.

2. (canceled)

3. A radio node comprising:
a communication interface comprising a receiver; and
processing circuitry associated with the communication interface, the processing circuitry configured to cause the radio node to:
estimate channel characteristics or receiving channel characteristics through signaling; and
depending on the channel characteristics, perform Demodulation Reference Signal, DMRS, Orthogonal Cover Code, OCC, decoding based on either: (a) sub-length orthogonal Frequency Domain OCC, FD-OCC, combined with sub-length orthogonal Time Domain OCC, TD-OCC, over one or more additional DMRS symbols or (b) FD-OCC.

4. A method performed by a radio node, the method comprising:
transmitting Physical Downlink Shared Channel, PDSCH, or Physical Uplink Shared Channel, PUSCH, Demodulation Reference Signal, DMRS, using Time Domain Orthogonal Cover Codes, TD-OCC over additional DMRS symbols and Frequency Domain Orthogonal Cover Codes, FD-OCC, such that the DMRS ports are separable based on FD-OCC and such that the DMRS ports are separable based on TD-OCC over additional DMRS symbols.

5. The method of claim 4 wherein a separate FD-OCC is applied for each of the DMRS ports and a separate TD-OCC is applied for each of the DMRS ports.

6. A radio node comprising:
a communication interface comprising a transmitter; and
processing circuitry associated with the communication interface, the processing circuitry configured to cause the radio node to:
transmit Physical Downlink Shared Channel, PDSCH, or Physical Uplink Shared Channel, PUSCH, Demodulation Reference Signal, DMRS, using Time Domain Orthogonal Cover Codes, TD-OCC over additional DMRS symbols and Frequency Domain Orthogonal Cover Codes, FD-OCC, such that the DMRS ports are separable based on FD-OCC and such that the DMRS ports are separable based on TD-OCC over additional DMRS symbols.

7. The radio node of claim 6 wherein a separate FD-OCC is applied for each of the DMRS ports and a separate TD-OCC is applied for each of the DMRS ports.

8. A method performed by a radio node, the method comprising:
transmitting Physical Downlink Shared Channel, PDSCH, or Physical Uplink Shared Channel, PUSCH, Demodulation Reference Signal, DMRS, using Time Domain Orthogonal Cover Codes, TD-OCC over additional DMRS symbols and Frequency Domain Orthogonal Cover Codes, FD-OCC, such that the DMRS ports are separable based on full length FD-OCC and such that the DMRS ports are separable based on sublength FD-OCC combined with TD-OCC over additional DMRS symbol.

9. The method of claim 8 wherein a separate FD-OCC is applied for each of the DMRS ports and a separate TD-OCC is applied for DMRS ports for which the applied FD-OCC are not sublength orthogonal.

10. A radio node comprising:
a communication interface comprising a transmitter; and
processing circuitry associated with the communication interface, the processing circuitry configured to cause the radio node to:
transmit Physical Downlink Shared Channel, PDSCH, or Physical Uplink Shared Channel, PUSCH, Demodulation Reference Signal, DMRS, using Time Domain Orthogonal Cover Codes, TD-OCC over additional DMRS symbols and Frequency Domain Orthogonal Cover Codes, FD-OCC, such that the DMRS ports are separable based on full length FD-OCC and such that the DMRS ports are separable based on sublength FD-OCC combined with TD-OCC over additional DMRS symbol.

11. The radio node of claim 10 wherein a separate FD-OCC is applied for each of the DMRS ports and a separate TD-OCC is applied for DMRS ports for which the applied FD-OCC are not sublength orthogonal.

12-51. (canceled)
